(19) United States
(12) Patent Application Publication
(10) Pub. No.: US 2026/0093961 A1
(43) Pub. Date: Apr. 2, 2026

(54) METHOD AND APPARATUS FOR DETERMINING PHYSICAL STATE OF AN OBJECT

(71) Applicant: Robert Bosch GmbH, Stuttgart (DE)

(72) Inventors: Jianing Huang, Shanghai (CN); Youjia Wu, Shanghai (CN); Kaixuan Zhang, Shanghai (CN); Ze Cheng, Shanghai (CN)

(21) Appl. No.: 19/342,526

(22) Filed: Sep. 27, 2025

(30) Foreign Application Priority Data
Sep. 30, 2024 (CN) 2024 1138 7911.4

(51) Int. Cl. G06N 3/0475; G06N 3/08

(52) U.S. Cl. CPC G06N 3/0475; G06N 3/08

(57) ABSTRACT

A computer-implemented method for determining the physical state of an object having a shape includes (i) dividing the shape of the object into a plurality of sub-shapes, (ii) obtaining a local solution for each of the plurality of sub-shapes through a neural network model based on a global boundary condition for the shape and the plurality of sub-shapes, wherein the local solution for each sub-shape represents the local physical state of the object having the sub-shape, and (ii) obtaining a global solution for the shape based on the local solution for each sub-shape in the plurality of sub-shapes, wherein the global solution for the shape represents the physical state of the object.

This application claims priority under 35 U.S.C. § 119 to application no. CN 2024 1138 7911.4, filed on Sep. 30, 2024 in China, the disclosure of which is incorporated herein by reference in its entirety.

The present application relates to artificial intelligence technology, and more particularly, to a method and apparatus for determining the physical state of an object.

### BACKGROUND

Neural network (NN) models, such as NN operators, are increasingly popular for solving partial differential equations (PDEs) due to their remarkable ability to capture complex mappings between function spaces across intricate domains. However, existing frameworks that rely on shape-specific NN models pose a significant barrier to their widespread application. One key challenge is that training NN models requires a substantial amount of data. In structural engineering, for instance, a product may have a unique shape, necessitating an NN model specifically designed for that shape to accurately calculate its physical state-such as velocity, pressure, temperature, or electric and magnetic fields. Consequently, this NN model must be trained using data tailored to that specific shape. Unfortunately, the availability of sufficient training data for these unique shapes can be limited, often leading to suboptimal performance of the NN model.

Conversely, the NN models in the existing frameworks struggle to generalize from the shapes represented in the training data to entirely new shapes (e.g. shapes that were not included in the training set). For instance, a first NN model may be trained on a first shape (e.g. corresponding to a first product). When applied to a second product with a second shape that is distinctly different from the first shape, the first NN model may yield unsatisfactory predictions of the second product's physical state. In such a case, it becomes necessary to retrain a second NN model specifically for the second shape. This process leads to inefficiencies and limits the practical application of NN models in real-world industrial scenarios.

Thus, there is a need for an enhanced system for determining the physical state of an object, one that allows the NN model to operate independently of the shape of a specific product and can generate sufficient training data for the NN model. Such an improved system would enable the NN model to generalize effectively to any shape, facilitating accurate predictions of the physical states of various objects with different shapes. This approach would significantly enhance the efficiency of NN models in practical industrial applications.

### SUMMARY

The following introduction is provided in order to introduce some selected concepts in a simple manner, and these concepts will be further described in the detailed description below. The introduction is not intended to highlight the key or necessary features of the claimed subject matter, nor is it intended to limit the scope of the claimed subject matter.

To address the above issues, this application provides a novel computer-implemented method for generating training data and, accordingly, a novel framework for determining the physical state of an object having a shape using an NN model. By employing the method of various examples of this application, sufficient training data can be generated for the NN model to achieve optimal performance. Furthermore, the physical states of arbitrarily shaped objects can be determined based on the trained NN model, thereby improving the efficiency of NN model training and usage.

According to one aspect of the present application, a computer-implemented method for generating training data is provided, comprising: generating a basic shape; configuring the boundary conditions associated with a first partial differential equation (PDE) for the boundary of the basic shape; determining a solution of the first PDE for the basic shape based on the basic shape and the boundary conditions, wherein the solution represents the physical state of an object having the basic shape; and wherein the training data is obtained based on the basic shape, the boundary conditions, and the solution.

According to one aspect of the present application, a computer-implemented method for training a neural network (NN) model for determining the physical state of an object having a shape is provided, comprising: based on training data generated by the method according to examples of the present disclosure, predicting, by the NN model, the solution for the basic shape in the training data, wherein the solution represents the physical state of the object having the basic shape; determining a loss based on the solution predicted by the NN model and the solution in the training data; and updating learnable parameters of the NN model based on the loss.

According to one aspect of the present application, a computer-implemented method for determining the physical state of an object having a shape is provided, comprising: dividing the shape of the object into a plurality of sub-shapes, wherein the full set of plurality of sub-regions corresponding to the plurality of sub-shapes covers the complete area of the shape; based on a global boundary condition for the shape and the plurality of sub-shapes, obtaining a local solution for each of the plurality of sub-shapes through a neural network (NN) model, the local solution for each sub-shape representing the local physical state of the object having the sub-shape; and obtaining a global solution for the shape based on the local solution for each sub-shape in the plurality of sub-shapes, the global solution for the shape representing the physical state of the object.

According to one aspect of the present application, a computer-implemented method for performing structural optimization of an object is provided, comprising: predicting the physical state of the object using the method according to the present application; and updating the structural features of the object based on the predicted physical state of the object.

According to one aspect of the present application, an apparatus for generating training data is provided, comprising: a shape generation module, which generates a basic shape; a boundary condition module, which configures the boundary conditions associated with a first partial differential equation (PDE) to the boundary of the basic shape; a solution module, which determines a solution of the first PDE for the basic shape based on the basic shape and the boundary conditions, wherein the solution represents the physical state of an object having the basic shape; and wherein the training data is obtained based on the basic shape, the boundary conditions, and the solution. According to one aspect of the present application, an apparatus for training a neural network (NN) model for determining the physical state of an object having a shape is provided, comprising: an NN model, which predicts a solution for the basic shape based on the basic shape and the boundary conditions in training data generated according to the method of examples of the present disclosure, wherein the solution represents the physical state of the object having the basic shape; a loss module, which determines a loss based on the solution predicted by the NN model and the solution in the training data; and an update module, which updates learnable parameters of the NN model based on the loss.

According to one aspect of the present application, an apparatus for determining the physical state of an object having a shape is provided, comprising: a partitioning module, which partitions the shape of the object into a plurality of sub-shapes, wherein the full set of the plurality of sub-regions corresponding to the plurality of sub-shapes covers the complete area of the shape; a local solution module, which obtains a local solution for each of the plurality of sub-shapes through a neural network (NN) model based on the global boundary conditions for the shape and the plurality of sub-shapes, wherein the local solution for each sub-shape represents the local physical state of the object having the sub-shape; and a global solution module, which obtains a global solution for the shape based on the local solution for each sub-shape in the plurality of sub-shapes, wherein the global solution for the shape represents the physical state of the object.

According to one aspect of the present application, an apparatus for performing structural optimization of an object is provided, comprising: a prediction module, which uses the method according to examples of the present disclosure to predict the physical state of the object; and an update module, which updates the structural features of the object based on the predicted physical state of the object.

According to one aspect of the present application, a processing apparatus is provided, comprising: one or more processors; and one or more memories storing computer-executable instructions, that, when executed by the one or more processors, perform at least one of the following operations according to examples of the present disclosure: generating training data, training an NN model for determining the physical state of an object having a shape, determining the physical state of an object having a shape, and performing structural optimization of the object.

According to one aspect of the present application, a machine-readable storage medium is provided, which stores executable instructions that, when executed, cause one or more processors to perform at least one of the following operations according to examples of the present disclosure: generating training data, training an NN model for determining the physical state of an object having a shape, determining the physical state of an object having a shape, and performing structural optimization of the object.

According to one aspect of the present application, a computer program product is provided, which comprises executable instructions that, when executed, cause one or more processors to perform at least one of the following operations according to examples of the present disclosure: generating training data, training an NN model for determining the physical state of an object having a shape, determining the physical state of an object having a shape, and performing structural optimization of the object.

### BRIEF DESCRIPTION OF THE DRAWINGS

The nature and advantages of the content of the present application may be further implemented by referring to the following accompanying drawings. In the drawings, similar components or features may have the same reference signs.

FIG. 1 is a block diagram of an apparatus for generating training data and training an NN model according to one example.

FIG. 2A is a schematic diagram of a basic shape generated according to one example.

FIG. 2B is a schematic diagram of a discretized basic shape generated according to one example.

FIG. 2C is a schematic diagram of a shape generation module according to one example.

FIG. 3A is a schematic diagram of a basic shape configured with a single boundary condition according to one example.

FIG. 3B is a schematic diagram of a basic shape configured with mixed boundary conditions according to one example.

FIG. 3C is a schematic diagram of a boundary condition module according to one example.

FIG. 4A is a schematic diagram of a solution for a basic shape determined according to one example.

FIG. 4B is a schematic diagram of a data-augmented basic shape and solution after data augmentation according to one example.

FIG. 5 is a schematic diagram of a method for training an NN model according to one example.

FIG. 6A is a block diagram of an apparatus for determining the physical state of an object having a shape according to one example.

FIG. 6B is a schematic diagram of determining the physical state of an object having a shape according to one example.

FIG. 7A is a schematic diagram of dividing a shape into a plurality of non-overlapping sub-shapes according to one example.

FIG. 7B is a schematic diagram of dividing a shape into a plurality of overlapping sub-shapes according to one example.

FIG. 7C is a schematic diagram of an overlapping partitioning module according to one example.

FIG. 8 is a schematic diagram of a local solution module according to one example.

FIG. 9 is a schematic diagram of a global solution module according to one example.

FIG. 10 is a schematic diagram of shapes and the data efficiency of applying SNI to each shape according to an example of the present disclosure.

FIG. 11 is a schematic diagram of an object having a shape according to one example.

FIG. 12 is a flow chart of a method for structural optimization of an object according to one example.

FIG. 13 is a flow chart of a computer-implemented method for generating training data according to one example.

FIG. 14 is a flow chart of a computer-implemented method for training an NN model for determining the physical state of an object having a shape according to one example.

FIG. 15 is a flow chart of a computer-implemented method for determining the physical state of an object having a shape according to one example.

FIG. 16 is a flow chart of a computer-implemented method for performing structural optimization of an object according to one example.

FIG. 17 is a block diagram of an apparatus for generating training data according to one example.

FIG. 18 is a block diagram of an apparatus for training an NN model for determining the physical state of an object having a shape according to one example.

FIG. 19 is a block diagram of an apparatus for determining the physical state of an object having a shape according to one example.

FIG. 20 is a block diagram of an apparatus for performing structural optimization on an object according to one example.

FIG. 21 is a block diagram of a processing apparatus according to one example.

### DETAILED DESCRIPTION

The subject matter described herein will now be discussed with reference to exemplary implementations. It should be understood that discussions about these embodiments are provided to aid those skilled in the art in better understanding and thereby implementing the subject matter described herein rather than limiting the scope of protection, applicability, or examples described in the patent claims. Changes may be made to the functions and arrangements of the elements discussed without departing from the scope of protection of the content of the present application. Various processes or components may be omitted, substituted, or added in the various examples as needed. For example, the described method may be performed in a different order than that described, and various steps may be added, omitted, or combined. In addition, features described in relation to some examples may also be combined in other examples.

As used herein, the term “comprise” and its variations are open terms, which mean “including but not limited to.” The term “based on” indicates “at least partially based on.” The terms “one example” and “an example” indicate “at least one example.” The term “another example” indicates “at least one other example.” The terms “first,” “second,” etc. may refer to different or same objects. Other definitions, whether explicit or implied, may be included below. Unless explicitly stated in the context, the definition of one term is consistent throughout the description. [symbol]
(1) of partial differential equations (PDEs) are crucial for many industries. For example, PDE solvers may be used to optimize structures in engineering systems. For example, a static PDE problem may be defined as follows:
where [symbol] is a partial differential operator, such as an elliptic partial differential operator, and Γ_{D}∪Γ_{N}=∂Ω denotes the Dirichlet and Neumann bou [symbol] (u)=f ions, respectively. It can be assumed that all domains Ω are bounded orientable manifold u=u_{D} in the ambient Euclidean space [symbol] ⁿ. It should be understood that the above static PDE pr

$$\frac{\partial u}{\partial n} = g$$

an example, and the present disclosure's solution is also applicable to static PDE problems based on other models, as well as dynamic PDE problems (e.g., time-dependent PDE problems).

An NN model for a PDE may be trained using training data to learn a mapping [symbol] : A→ [symbol] between two spaces, where [symbol] may be the solution space of the PDE and A may be the function space used to determine the solution of the PDE. Examples of A include PDE parameter functions (e.g., including coefficients (e.g., coefficient fields) and/or source terms) used to define the PDE, boundary conditions/initial conditions, or parameters used to define the shape in the domain.

According to various examples of the present application, the A for a PDE in the training data may be generated without being restricted to specific PDE parameter functions, boundary conditions, or shapes, thereby generating sufficient training data. The training data in various examples of the present application may fully train the NN model and enable it to achieve good generalization capabilities. Accordingly, the geometric shapes in the domain Ω_{inf} used for inference using the NN model may be decoupled from the shapes in the domain Ωₜᵣₐᵢₙ used for training the NN model. In other words, the shapes in Ω_{inf} do not need to fall within or be similar to the shapes used during training; they can be any shape.

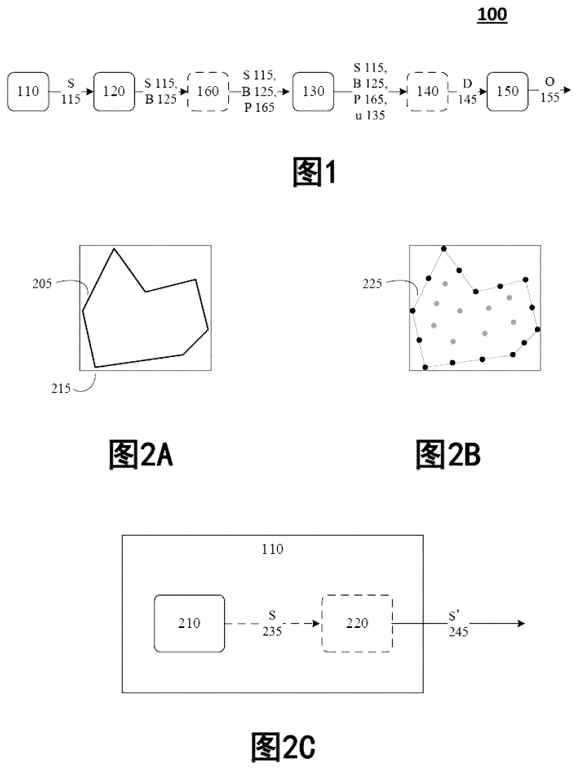

FIG. 1 is a block diagram of an apparatus 100 for generating training data and training an NN model, according to one example. In the example shown in FIG. 1, the apparatus 100 comprises a shape generation module 110, a boundary condition module 120, an (optional) PDE parameter function module 160, a solution module 130, an (optional) data augmentation module 140, and a NN model 150. It will be appreciated that the apparatus 100 may comprise other modules; FIG. 1 only shows modules relevant to the present example.

The shape generation module 110 may generate a basic shape S 115. In an example of the present disclosure, the selection of a basic shape needs to ensure that the NN model can solve the PDE problem for various shapes. A probability space ( [symbol] , μ) may be specified, where μ represents the probability distribution over the shape space [symbol] . In one example, preferably, the generated basic shape meets two conditions: (1) sampling feasibility: it should be easy to sample from μ and solve the boundary value problem on the shapes in [symbol] in order to generate data for NN model learning; (2) entire coverage: the basic shape in [symbol] should flexibly cover any shapes in the domain.

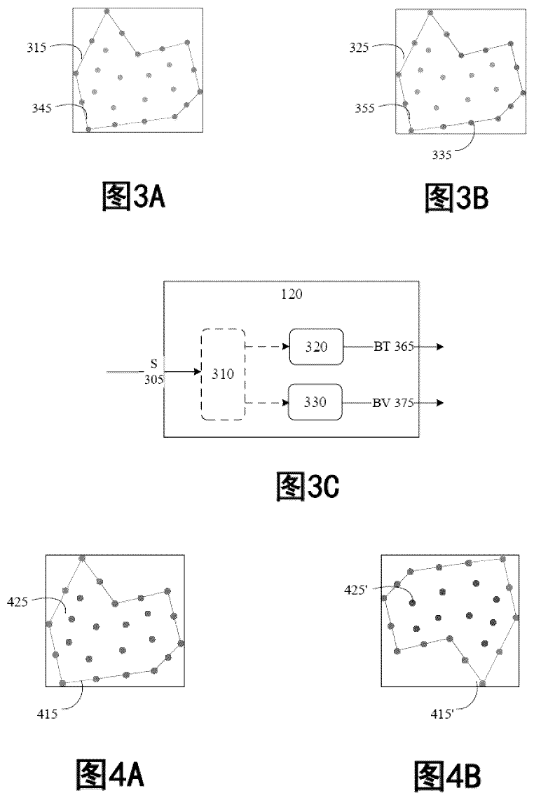

In one example, the domain Ω⊆ [symbol] ². A space [symbol] ₛ(n) of simple polygons (i.e., planar polygons without self-intersections and holes) with at most n vertices, uniformly constrained by a specific area in [symbol] ², may be used. For example, the specific area may be the predetermined range 215 shown in FIG. 2A, or another suitable area. Simple polygons are Lipschitz domains with straightforward sampling methods and are flexible enough to construct any discretized planar domain. It will be appreciated that any other basic shapes, such as convex polygons, star-shaped polygons, etc., may also be generated if the above two criteria are met.

FIG. 2A is a schematic diagram of a basic shape 205 generated according to one example. In one example, the basic shape may comprise a planar polygon with no self-intersections and no holes. For example, the planar polygon may comprise n vertices (e.g., 3≤n≤12). For example, the basic shape 205 may be confined to a predetermined range 215. For example, the predetermined range 215 may be the unit square [0.5, 0.5]²⊂ [symbol] ².

In one example, the basic shape may be represented discretely. FIG. 2B is a schematic diagram of a discretized basic shape 225 generated according to one example. For example, the basic shape may be discretized through sampling. The discretized basic shape may be represented by coordinate points on the edge of (and within) the basic shape.

FIG. 2C is a schematic diagram of a shape generation module 110 according to one example. In the example of FIG. 2C, the shape generation module 110 comprises a planar polygon generation module 210 and an optional sampling module 220. It will be appreciated that the shape generation module 110 may comprise other modules, and FIG. 2C only illustrates modules relevant to the present example.

The shape generation module 110 may generate the basic shape S 235 through the planar polygon generation module 210. For example, the number of vertices n may be specified to a planar polygon generation module 210, and the planar polygon generation module 210 may randomly generate a planar polygon S 235 including n vertices within a predetermined range. For another example, the planar polygon generation module 210 may randomly determine the number of vertices n of the planar polygon and randomly generate a planar polygon S 235 including n vertices within the predetermined range. In one example, 3≤n≤12.

The shape generation module 110 may also optionally comprise a sampling module 220. For example, the sampling module may sample the basic shape S 235 generated by the planar polygon generation module 210 to generate a discrete basic shape S′ 245.

Referring back to FIG. 1, the shape generation module 110 may output the generated basic shape S 115, and the boundary condition module 120 may configure the basic shape S 115 with a boundary condition B 125 associated with the first PDE. According to an example of the present application, a boundary condition may be associated with a boundary condition type and a boundary condition value range. Configuring the boundary condition associated with the first PDE for the boundary of the basic shape may comprise configuring the following items for the boundary of the basic shape:
(1) Type of boundary condition: The boundary of the basic shape may be configured with a single boundary condition or mixed boundary conditions. In the case of a single boundary condition, the entire boundary of the basic shape may be configured with the same type of boundary condition. In the case of mixed boundary conditions, the boundary of the basic shape may be configured with a plurality of types of boundary conditions. For example, different parts of the boundary of the basic shape may be respectively configured with corresponding types of boundary conditions. In one example, the basic shape may be discretized, and configuring the type of boundary condition for the boundary of the basic shape may comprise configuring the type of boundary condition for discrete points on the boundary of the basic shape.
(2) Value range of boundary condition: The values of the boundary conditions for the basic shape may be in numerical form or in functional form. The reasoning process in the domain may encounter arbitrary value range in boundary conditions, but it is generally not feasible to include unbounded boundary condition values in the training data used to train the NN model. Therefore, value ranges of boundary conditions in the form of numerical values or functions may be configured in the training data. In one example, the basic shape may be discretized, and configuring the value range of the boundary condition for the boundary of the basic shape may comprise configuring the value range of the boundary condition for discrete points on the boundary of the basic shape.

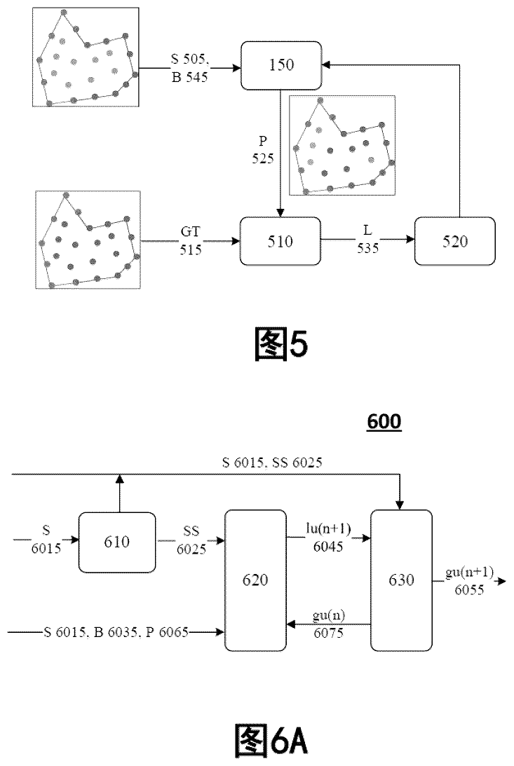

FIG. 3A is a schematic diagram of a basic shape 345 configured with a single boundary condition according to one example. In one example, in the case of a single boundary condition, the entire boundary of the basic shape 345 may be configured with the same type of boundary condition 315. For example, the basic shape 345 may be discretized, and a single type of boundary condition may be configured for each discrete point on the boundary of the basic shape 345. For example, the boundary condition may include one of a Dirichlet boundary condition, a Neumann boundary condition, and a Robin boundary condition. It will be appreciated that any other suitable type of boundary condition may be configured for the boundary of the basic shape.

FIG. 3B is a schematic diagram of a basic shape 355 configured with mix boundary conditions according to one example. In one example, with mixed boundary conditions, the boundary of basic shape 355 may be configured with a plurality of types of boundary conditions. For example, the basic shape 355 may be discretized, and a plurality of types of boundary conditions may be configured for discrete points on the boundary of the basic shape 355. For example, the boundary of the basic shape may be partitioned into a first portion and a second portion, and a first type of boundary condition 325 may be configured for the first portion of basic shape 355, while a second type of boundary condition 335 may be configured for the second portion of basic shape 355. In one example, the first type of boundary condition may be a Dirichlet boundary condition, and the second type of boundary condition may be a Neumann boundary condition. For example, the plurality of types of boundary conditions may include at least two of the following: a Dirichlet boundary condition, a Neumann boundary condition, and a Robin boundary condition. It will be appreciated that any other suitable types of a plurality of boundary conditions may also be configured for the boundary of the basic shape.

FIG. 3C is a schematic diagram of a boundary condition module 120 according to one example. In the example of FIG. 3C, the boundary condition module 120 comprises an optional partitioning module 310, a boundary condition type configuration module 320, and a boundary condition value configuration module 330. It will be appreciated that the boundary condition module 120 may comprise other modules; FIG. 3C only illustrates modules relevant to the present example.

When a single boundary condition is configured for the boundary of a basic shape, the boundary of the basic shape does not need to be partitioned by the partitioning module 310. When mixed boundary conditions are configured for the boundary of a basic shape, the partitioning module 310 may partition the boundary of the basic shape S 115 into a plurality of sections. In one example, the partitioning module 310 may randomly partition the boundary of the basic shape S 115 into a plurality (e.g., two) of connected sections. The partitioning module 310 may output the partitioned sections to the boundary condition type configuration module 320 and the boundary condition value configuration module 330.

When configuring a single boundary condition for the boundary of a basic shape, the boundary condition type configuration module 320 may configure a type of boundary condition BT 365 for the boundary of basic shape 305. For example, a Laplace2d-Dirichlet type PDE is a two-dimensional (2D) Laplace equation with a single Dirichlet boundary condition. It may be used to solve problems related to electric or magnetic field distributions for structural design or materials engineering problems of industrial products such as batteries (e.g., fuel cell bipolar plates), electrothermal devices, and electromagnets. For a Laplace2d-Dirichlet type PDE, the boundary condition type configuration module 320 may configure a single Dirichlet boundary condition for the basic shape. The Laplace2d-Dirichlet is constrained by the following equation:

$$in Ω , Δ u = 0 \qquad ( 2 )$$

$$on \partial Ω , u = {u}_{D}$$

For another example, a Darcy2d PDE is a 2D Darcy flow with a coefficient field a(x) and a source term f(x) and a single Dirichlet boundary condition. This can be used to solve problems related to seepage (e.g., fluid velocity, pressure, etc.) for structural design or materials engineering problems of industrial products such as hydraulic structures or water collection structures. For a Darcy2d PDE, the boundary condition type configuration module 320 may configure a single Dirichlet boundary condition for the basic shape. Darcy2d is constrained by the following equation:

$$in Ω , - ∇ ( a ( x ) ∇ u ) = f ( x ) \qquad ( 3 )$$

$$on \partial Ω , u = {u}_{D}$$

For another example, a Heat2d PDE is a 2D time-varying heat conductivity equation with a coefficient α representing thermal diffusivity, time-varying boundary conditions, and initial conditions. It can be used to solve problems related to temperature distribution, and is applicable to structural design or materials engineering problems for industrial products such as electrothermal devices, batteries, building materials design, refrigeration, and insulation materials. For a Heat2d PDE, the boundary condition type configuration module 320 may configure a Dirichlet boundary condition for the basic shape. Heat2d is constrained by the following equation:

$$in Ω \times [ 0 , ⊤ ] \frac{\partial u}{\partial t} = αΔ u \qquad ( 4 )$$

$$on \partial O \times [ 0 , ⊤ ] , u ( x , t ) = {u}_{D} ( x , t )$$

$$on Ω \times \{ 0 \} , u ( x , 0 ) = {u}_{0} ( x )$$

When configuring mixed boundary conditions for the boundary of a basic shape, the boundary condition type configuration module 320 may configure a plurality of types of boundary conditions BT 365 for the boundary of the basic shape 305. For example, for each of the plurality of sections into which the basic shape is partitioned, the boundary condition type configuration module 320 may configure one of the plurality of boundary condition types. For example, a Laplace2d-Mixed PDE is a 2D Laplace equation with mixed Dirichlet and Neumann boundary conditions on ∂Ω=Γ_{D}∪Γ_{N}. This can be used to solve problems related to electric or magnetic field distributions, and is used in structural design or materials engineering problems for industrial products such as batteries (e.g., fuel cell bipolar plates), electrothermal devices, and electromagnets. For a Laplace2d-Mixed PDE, the boundary condition type configuration module 320 may configure Dirichlet and Neumann boundary conditions for different sections of the basic shape. The Laplace2d-Mixed is constrained by the following equation:

$$in Ω , Δ u = 0 \qquad ( 5 )$$

$$on {Γ}_{D} , u = {u}_{D}$$

$$on Γ , \frac{\partial u}{\partial n} = g$$

The value of the boundary condition for the basic shape may be in numerical or functional form. The boundary condition value configuration module 330 may configure the boundary condition value BV 375 in numerical or functional form. For example, for the (partitioned) basic shape, the boundary condition value configuration module 330 may generate (e.g., using a random function) a random value within a predetermined range (e.g., within [0, 1]), and the boundary condition value in numerical or functional form may be based on the random value (e.g., equal to the random value, or a piecewise linear function determined by the random value, etc.).

In one example, the boundary condition module 120 may output a boundary condition B 125 configured for the basic shape, which comprises a boundary condition type BT 365 and a boundary condition value BV 375.

Referring back to FIG. 1, the apparatus 100 may optionally comprise a PDE parameter function module 160 that configures a PDE parameter function P 165 associated with a first PDE for a basic shape S 115. PDE parameter function P 165 may comprise coefficients associated with the first PDE (e.g., coefficient field a(x) in equation (3), α in equation (4)) and/or source terms (e.g., f(x) in equation (3)). In one example, the PDE parameter function module 160 may generate a random value within a predetermined range (e.g., within [0, 1]) (e.g., using a random function), and the value of PDE parameter function P 165 associated with the first PDE may be based on the random value (e.g., equal to the random value, or a piecewise linear function determined by the random value, etc.).

The apparatus 100 may comprise a solution module 130 that determines a solution u 130 for a first PDE for the basic shape based on the basic shape S 115 and the boundary condition B 125 (and optionally, a PDE parameter function P 165), wherein the solution u 130 represents the physical state of an object having the basic shape. In some examples, for the first PDE, the solution module 130 may determine the solution u 130 for the basic shape by numerically solving. For example, for the first PDE, a numerical solution method such as the finite element method (FEM) may be employed to determine the solution u 130 for the basic shape. The first PDE may be a static PDE (e.g., the Laplace2d-Dirichlet, Darcy2d, or Laplace2d-Mixed PDEs described above, or any other static PDE), or a dynamic (e.g., time-varying) PDE (e.g., the Head2d PDE described above, or any other dynamic PDE).

For example, in the case of a dynamic PDE, the solution may represent the physical state of an object with a basic shape over time. For example, the first PDE may be a time-varying PDE equation (e.g., Head2d as described above). In one example, the time-varying PDE equation may be constrained by the following equation:

$$in Ω \times [ 0 , ⊤ ] , {u}_{t} - ℒ u = f \qquad ( 6 )$$

$$on \partial Ω \times [ 0 , ⊤ ] , u ( x , t ) = {u}_{D} ( x , t )$$

$$on Ω \times \{ 0 \} , u ( x , 0 ) = {u}_{0} ( x )$$

wherein, £ is a partial differential operator, such as an elliptic partial differential operator. The method according to an example of the present disclosure may be applied to a dynamic PDE in the time-space dimension, such as that shown in the above equation (6). For example, the method according to an example of the present disclosure may be applied to a dynamic PDE in the time-space dimension by decomposing the time-space domain Ω×[0, T]. The time-space domain decomposition may have the form Ωᵢ×[tⱼ₋₁−δ_{T}, tⱼ+δ_{T}], wherein δ_{T} is the time depth and represents the overlap in the time domain. After such a time-space domain decomposition is established, the method according to an example of the present disclosure may be applied to the time-space domain to obtain a global solution in the time-space domain. According to one example, it may be iterated in parallel in the space domain and the time domain. In an example of a PDE for heat dissipation, such as that shown in FIG. 8), a fixed time step tₛ and an inference length k may be used to discretize the time domain to the time points t=0, tₛ, . . . , (k−1) tₛ. Accordingly, the solutions u(x, 0), u(x, tₛ), . . . , u(x, (k−1) tₛ) of the solution module 130 may represent the physical state of the object with the basic shape at time t=0, tₛ, . . . , (k−1) tₛ.

FIG. 4A is a schematic diagram of a solution 425 for a basic shape 415 determined according to one example. For example, the basic shape 415 may be discretized, and the solution module 130 may determine the solution 425 at discrete points within the boundary of the basic shape 415 under the constraints of the first PDE and its boundary conditions.

According to one aspect of the present application, to improve the generalization ability of an NN model, data augmentation may be performed to include more data in the training data (e.g., to provide more comprehensive information). The symmetry group of a general partial differential operator £ refers to a set of transformations that map one solution to another. By exploiting symmetries, a plurality of new solutions may be generated based on a given solution.

Referring back to FIG. 1, the apparatus 100 may optionally comprise a data augmentation module 140 that performs data augmentation based on at least one of the following: the basic shape S 115, the boundary condition value in the boundary condition B 125, the PDE parameter function P 165, and the solution u 135, to obtain at least one of the following: the data-augmented basic shape, the data-augmented boundary condition value, the data-augmented PDE parameter function, and the data-augmented solution. Training data D 145 is based on at least one of the following: a data-augmented basic shape, a data-augmented boundary condition value, a data-augmented PDE parameter function, and a data-augmented solution, and based on the basic shape, the boundary conditions, the PDE parameter function, and the solution.

In one example, the data augmentation module 140 may perform data augmentation based on the basic shape. For example, the data augmentation module 140 may perform at least one of the following: spatial translation, spatial scaling, and/or spatial rotation on the basic shape, to obtain a data-augmented basic shape.

For example, for any point X (x1, x2) in the basic shape S, performing spatial translation on the basic shape may comprise transforming the point X: (x₁, x₂)→(x₁+t₁, x₂+t₂), performing spatial rotation on the basic shape may comprise transforming the point X: (x₁, x₂)→(x₁ cos θ−x₂ sin θ, x₁ sin θ+x₂ cos θ), and performing spatial scaling on the basic shape may comprise transforming the point X: (x₁, x₂)→(sx₁, sx₂).

In one example, when spatial scaling is performed on the basic shape, the value, solution, and PDE parameter function of the boundary condition in the boundary condition do not necessarily need to be data-augmented to match the data-augmented basic shape (for example, when the first PDE is a Laplace2d-Dirichlet type PDE described above with reference to equation (2)). In one example, when spatial scaling is performed on the basic shape, the data augmentation module 140 may further perform data augmentation on at least one of the value, solution, and PDE parameter function of the boundary condition in the boundary condition to ensure that at least one of the value, solution, and PDE parameter function of the data-augmented boundary condition matches the data-augmented basic shape. For example, in the case of performing spatial scaling (x1, x2)→(sx1, sx2) on the basic shape, for the PDE of Darcy2d type described above with reference to equation (3), the data augmentation module 140 may also perform the following transformation (e.g., value scaling) on the coefficient field a(x) and source term f(x) in the solution u and the boundary condition u_{D} and PDE parameter function: u→su, u_{D}→su_{D}, a(x)→a(x), f(x)→f(x); for the PDE of Heat2d type described above with reference to equation (4), the data augmentation module 140 may also perform the following transformations (e.g., value scaling) of the solution u, u₀, the boundary condition u_{D}, and the coefficient α in the PDE parameter function: u→u, u₀→u₀, u_{D}→u_{D}, α→s²α; for the Laplace2d-Mixed type PDE described above with reference to equation (5), the data augmentation module 140 may also perform the following transformations (e.g., value scaling) of the solution u and the boundary conditions u_{D}, g:u→su, u_{D}→su_{D}, g→g.

For example, the data augmentation module 140 may perform data augmentation based on at least one of the following: the value of the boundary condition, the PDE parameter function, and the solution. For example, the data augmentation module 140 may perform value shift and/or value scaling on at least one of the following: the value of the boundary condition, the PDE parameter function, and the solution, to obtain the data-augmented value of the boundary condition, the data-augmented PDE parameter function, and the data-augmented solution.

In one example, the data augmentation module 140 may perform value shift on the solution u and the boundary condition u_{D} by performing the following transformations on the solution u and the boundary condition u_{D}: u→u+t, u_{D}→u_{D}+t. In one example, the data augmentation module 140 may perform value scaling on the solution u and the boundary condition u_{D} by performing the following transformations on the solution u and the boundary condition u_{D}: u→su, u_{D}→su_{D}. In one example, for the PDE of Heat2d type described above with reference to equation (4), the data augmentation module 140 may further perform value scaling by performing the following transformations on the solution u, u₀ and the boundary condition u_{D}: u→su, u₀→su₀, u_{D}→su_{D}; for the PDE of Laplace2d-Mixed type described above with reference to equation (5), the data augmentation module 140 may further perform value scaling by performing the following transformations on the solution u and the boundary conditions u_{D}, g:u→su, u_{D}→su_{D}, g→sg.

It is understood that the above transformations and combinations for performing data augmentation are merely examples, and the data augmentation module 140 may also perform any other suitable data augmentation on any one of the basic shapes, boundary condition values, PDE parameter functions, and solutions.

FIG. 4.B is a schematic diagram of a data-augmented basic shape 415′ and solution 425′ according to one example. For example, the data-augmented basic shape 415′ may be obtained by performing spatial rotation on the basic shape 415, and the data-augmented solution 425′ may be obtained by performing value shift and/or value scaling on the solution 425. In another example, only the spatial rotation may be performed on the basic shape 415 to obtain the data-augmented basic shape 415′, while the corresponding discrete point solution 425 remains unchanged.

Referring back to FIG. 1, training data may be generated based on the examples described herein to train the NN model 150, which may be used to determine the physical state of an object having a shape.

The NN model 150 may comprise a neural network model of any appropriate structure. For example, the NN model 150 may accommodate flexible input/output formats and have sufficient expressive power to solve local problems with randomly varying shapes and PDE parameter functions. For example, the NN model 150 may comprise neural network models such as GNOT, FNO, and DeepONet.

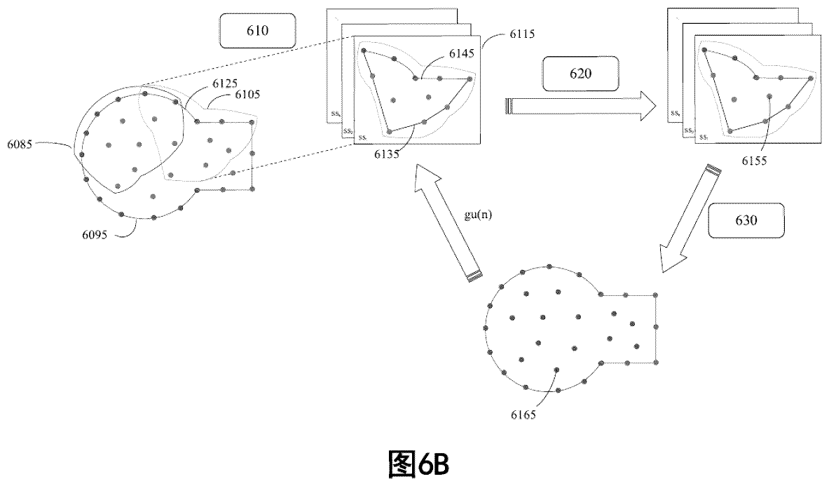

FIG. 5 is a schematic diagram of a method for training an NN model 150 according to one example. FIG. 5 shows the NN model 150, a loss module 510, and an update module 520. It will be appreciated that other modules may also be comprised, and FIG. 5 only shows modules relevant to the present example.

The NN model 150 may predict a solution P 525 for the basic shape based on the basic shape S 505 and the boundary condition B 545 in the training data D 145 generated according to the method described herein, wherein the solution P 525 represents the physical state of an object having the basic shape. The loss module 510 may comprise any suitable loss function, including an L1Loss function, an MSELoss function, or a cross-entropy function. The loss module 510 may determine a loss L 535 based on the solution P 525 predicted by the NN model and the solution GT 515 in the training data. The update module 520 may update the learnable parameters of the NN model 150 based on the loss L 535. It will be appreciated that any suitable optimization method may be used to update the learnable parameters of the NN model.

By training the NN model 150 using the training data described herein, the NN model 150 can learn to solve for basic shape. In particular, when the training data comprises data augmentation data, the NN model 150 can be more fully trained to capture complex details and variations in the basic shape.

When determining the physical state of an object with a certain shape, the object's shape may be relatively complex. This application proposes a novel Schwarz Neural Inference (SNI) method and apparatus, which first partitions a shape (e.g., relatively complex) into a plurality of sub-shapes; then applies a neural network model to each sub-shape to obtain a local solution for that sub-shape; and based on the local solution for each sub-shape, a global solution for the shape is obtained. This local-to-global approach of SNI enables the NN model for the first PDE to solve the PDE problems and based on any shape (not limited to the specific shapes used in the training phase) during the inference phase, determine the physical state of an object with that shape, thereby greatly improving the efficiency of NN models in practical industrial applications.

FIG. 6A is a block diagram of an apparatus 600 for determining the physical state of an object having a shape according to one example. In the example of FIG. 6A, the apparatus 600 comprises a partitioning module 610, a local solution module 620, and a global solution module 630. It will be appreciated that the apparatus 600 may comprise other modules; FIG. 6A only shows modules relevant to the present example.

The partitioning module 610 may partition the object's shape S 6015 into a plurality of sub-shapes SS 6025, wherein the entire set of sub-regions corresponding to the plurality of sub-shapes SS 6025 covers the complete area of the shape S 6015. For example, the partitioning module 610 may partition the shape S 6015 into the plurality of sub-shapes SS 6025 based on data representing the object's shape S 6015 in the structural data. In one example, the shape of the object in the structural data is represented by at least one of the following: center of circle, radius, width, height, length, grid, discrete point, or geometric pattern.

As shown in the example of FIG. 6B, an object may have a shape 6095, and a partitioning module 610 may partition shape 6095 into a plurality (e.g., K, where K is an integer greater than 1) of sub-shapes SS₁, SS₂, . . . , SS_{K}. For simplicity, FIG. 6B shows only two sub-shapes 6085 and 6105. Each of the plurality of sub-shapes may be within a predetermined range. For example, sub-shape 6105 may be within range 6115.

In this application, the boundary of the shape of an object may be referred to as a global boundary, and the boundary of a sub-shape may be referred to as a local boundary. Referring to the example in FIG. 6B, in one example, the boundary of shape 6095 may be associated with a global boundary condition 6125 (e.g., as shown by the red and green parts in FIG. 6B). Accordingly, at least a portion of the sub-shapes among the partitioned sub-shapes may be associated with a portion of the global boundary condition 6125. For example, the sub-shape 6105 may be associated with a portion of the global boundary condition 6145 (e.g., as shown by the red and green parts in SS1) in the global boundary condition 6125. The value of the portion of the global boundary condition 6145 of sub-shape 6105 may be the same as the value of the portion of the global boundary condition 6125 of shape 6095 corresponding to sub-shape 6105.

In one example, the boundary of sub-shape 6105 may be associated with a virtual boundary condition 6135 (e.g., shown as a gray part in SS1). For example, the virtual boundary condition 6135 of the sub-shape may be a boundary condition within the boundary of sub-shape 6105 that is not part of the boundary of shape 6095. For example, the virtual boundary condition 6135 of the sub-shape may comprise a boundary condition on the boundary consisting of points within the shape (e.g., not on the boundary of the shape). In one example, the local solution and the global solution for each sub-shape are obtained by a plurality of rounds of iteration, and the value of the virtual boundary condition 6135 of the sub-shape in the (n+1)th round may be based on the global solution gu(n) for shape 6095 from the previous round.

In one example, the local boundary condition of a sub-shape may comprise a portion of the global boundary condition and/or virtual boundary condition for the sub-shape. For example, the local boundary condition of the sub-shape 6105 may comprise a portion of the global boundary condition 6145 and the virtual boundary condition 6135.

The local solution module 620 may obtain a local solution for each of the plurality of sub-shapes SS 6025 based on the global boundary condition B 6035 for shape S 6015 and the plurality of sub-shapes SS 6025 (and the PDE parameter function 6065, if applicable) through a neural network (NN) model, and the local solution for each sub-shape represents the local physical state of the object with the sub-shape. The data representing the object's shape S 6015, the global boundary condition B 6035, and the optional PDE parameter function 6065 are referred to as structural data, representing the object's structure and the constraints of the physical system. In one example, the local solution and global solution for each sub-shape are obtained by a plurality of rounds of iteration, and the local solution module 620 may also obtain the local solution lu(n+1) of the n+1th round 6045 based on the global solution of the nth round gu(n) 6075. For example, the global solution gu(0) may be initialized before entering the local solution of round 1. For example, the global solution gu(0) may be set to a default value (eg, 0 or 1), or may be randomly initialized.

For example, local solution module 620 may obtain a local solution for each of the plurality of sub-shapes through the NN model based on each sub-shape and the local boundary conditions for each sub-shape. For example, for sub-shape 6105, the local solution module 620 may obtain a local solution for the points inside the sub-shape 6105 (e.g., illustrated by light blue dots) via the NN model based on the sub-shape 6105 and its associated local boundary conditions. While the light blue dots inside the shape 6105 are utilized in the FIG. 6B to represent the NN model obtaining a local solution for the internal points of the sub-shape 6105, in another example, the NN model may determine a local solution for all points of the sub-shape 6105 (including local boundary points and internal points) based on the shape 6105 and its associated local boundary conditions. During the iteration process, the value of the global boundary remains unchanged, while the value of the virtual boundary is updated at each iteration.

Referring back to FIG. 6A, the global solution module 630 in the apparatus 600 may obtain a global solution for the shape based on the local solution for each of the plurality of sub-shapes. The global solution for the shape represents the physical state of the object. In one example, the local solution and global solution for each sub-shape are obtained by a plurality of rounds of iteration, and the global solution gu(n+1) 6055 of the n+1th round may be based on the local solution lu(n+1) 6045 for each sub-shape.

Referring to the example in FIG. 6B, the global solution module 630 may extend and concatenate the local solution for each sub-shape to obtain a global solution 6165 for the shape 6095 (eg, as shown by the dark blue dots in FIG. 6B).

In one example, during the inference process, the PDE associated with the shape may be a dynamic PDE. Accordingly, the solution for the shape represents the temporal physical state of the object having the shape. In one example, the object may be at least one of the following: a fuel cell bipolar plate, a part of an automobile, a part of an aircraft, a part of a building, a reactor pipe, and a guide plate, and the physical state includes at least one of the following: velocity, pressure, temperature, electric field, and magnetic field.

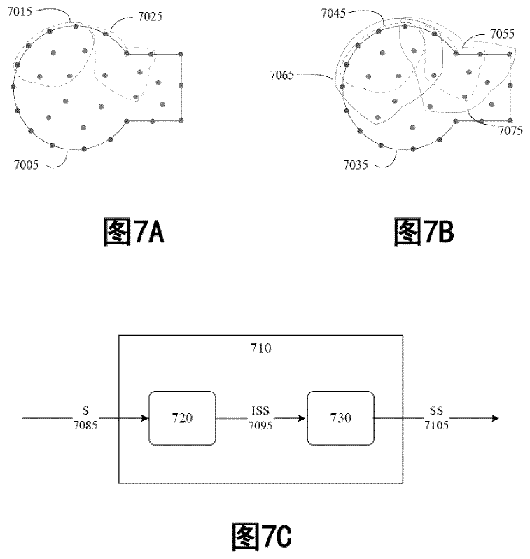

In one example, the partitioning module 610 may comprise a non-overlapping partitioning module that partitions a shape into a plurality of non-overlapping sub-shapes to form a plurality of non-overlapping sub-shapes, wherein the full set of the corresponding sub-regions of the plurality of sub-shapes covers the complete area of the shape. FIG. 7A is a schematic diagram of dividing a shape into a plurality of non-overlapping sub-shapes according to one example. For example, for simplicity, FIG. 7A only shows two sub-shapes 7015 and 7025 from the plurality of non-overlapping sub-shapes. In examples where the shape is discretized, any two sub-shapes of the plurality of non-overlapping sub-shapes may not comprise overlapping points. The partitioning module 610 may partition the shape into K non-overlapping sub-shapes based on a graph partitioning algorithm such as METIS, wherein K is an integer greater than 1. In one example, K may be pre-set. For example, K may be a hyperparameter.

In one example, the partitioning module 610 may comprise an overlapping partitioning module that partitions a shape into a plurality of overlapping sub-shapes to form overlapping sub-shapes, wherein the full set of sub-regions corresponding to the plurality of sub-shapes covers the complete area of the shape. In examples where the shape is discretized, at least two sub-shapes of the plurality of overlapping sub-shapes may comprise overlapping points. For example, overlapping partitioning of shapes may facilitate convergence of the SNI-based method in examples of the present disclosure, thereby more accurately determining the physical state of an object having a shape.

FIG. 7C is a schematic diagram of an overlapping partitioning module 710 according to one example. In the example of FIG. 7C, the overlapping partitioning module 710 comprises an intermediate partitioning module 720 and a shape extension module 730. It will be appreciated that the overlapping partitioning module 710 may comprise other modules, and FIG. 7C only shows modules relevant to the examples of the present disclosure.

The intermediate partitioning module 720 may partition the shape S 7085 into a plurality of non-overlapping sub-shapes to form a plurality of non-overlapping intermediate sub-shapes ISS 7095. In one example, the intermediate partitioning module 720 may comprise the aforementioned non-overlapping partitioning module, and the full set of sub-regions corresponding to the plurality of intermediate sub-shapes ISS 7095 may cover the complete area of the shape. In one example, the full set of sub-regions corresponding to the plurality of non-overlapping intermediate sub-shapes ISS 7095 partitioned by the intermediate partitioning module 720 may not cover the complete area of the shape, and thus the plurality of non-overlapping intermediate sub-shapes may be different from the plurality of non-overlapping sub-shapes. In the example where the shape S 7085 is discretized, any two intermediate sub-shapes of the plurality of non-overlapping intermediate sub-shapes may not comprise overlapping points, and at least one point in the shape may not be comprised in any intermediate sub-shape.

Referring to FIG. 7B, the intermediate partitioning module 720 may partition the shape 7035 into a plurality of non-overlapping intermediate sub-shapes. For simplicity, FIG. 7B only shows a first intermediate sub-shape 7045 and a second intermediate sub-shape 7055 among the plurality of intermediate sub-shapes.

Referring back to FIG. 7C, the overlapping partitioning module 710 may comprise a shape extension module 730 to extend part or all of the plurality of non-overlapping intermediate sub-shapes to form a plurality of overlapping sub-shapes. For example, in the example where the shape is discretized, the shape extension module 730 may iteratively comprise neighboring points in part or all of the intermediate sub-shapes to form a plurality of overlapping sub-shapes. In one example, this iteration may be performed d rounds, where d may be a preset extension depth d. For example, d may be a hyperparameter. In another example, this iteration may be performed until the full set of the plurality of sub-regions corresponding to the plurality of overlapping sub-shapes covers the complete area of the shape.

Referring to FIG. 7B, the shape extension module 730 may extend the first intermediate sub-shape 7045 into a first sub-shape 7065, and extend the second intermediate sub-shape 7055 into a second sub-shape 7075.

FIG. 8 is a schematic diagram of a local solution module 620 according to one example. According to the example of FIG. 8, the local solution module 620 may comprise a sub-shape operator generation module 8010, a sub-shape preprocessing module 8020, an NN model 8050, a post-processing module 8060, a local boundary condition module 8070, a value operator generation module 8080, and a value preprocessing module 8090. FIG. 8 also shows, outside of the local solution module 620, an optional PDE parameter function operator generation module 8030 and an optional PDE function parameter preprocessing module 8040. In one example, the PDE parameter function operator generation module 8030 and the PDE function parameter preprocessing module 8040 may also be comprised within the local solution module 620. It can be understood that the local solution module 620 may comprise other modules; FIG. 8 only shows modules relevant to the present example.

The range of sub-shapes and boundary conditions may differ from the range of the training data (e.g., training data generated according to the method described in the examples of the present disclosure) during inference on any partitioned sub-shapes. In order for the NN model trained based on the training data to be better adapted to the partitioned sub-shapes during the inference phase, the transformation T:P×H→P×H may be applied to convert local problems whose shapes or values are outside the range of the training data into the range of the training data, where P represents the space of the sub-shapes and H represents boundary conditions and optional PDE function parameters. In the examples of the present disclosure, the transformation T may be referred to as preprocessing. For example, the preprocessing may comprise at least one of the following: spatial translation, spatial scaling, value offset, and value scaling, wherein spatial translation and spatial scaling may be applied to sub-shapes, and the value offset and value scaling may be applied to PDE parameter functions and/or local boundary condition values. After inference through the NN model G:P×H→U, the resulting solution function may be transformed back through the appropriate inverse transformation Ť:U→U. The transformation may not be referred to as post-processing in the examples of the present disclosure. In examples where the range of the sub-shapes and boundary conditions may be the same as the range of the training data, the above preprocessing and post-processing of the sub-shapes and boundary conditions may not be performed, and preprocessing transformations and post-processing transformations may be determined or default preprocessing operators and post-processing operators may be used, which do not actually transform the sub-shapes and boundary conditions. For example, the preprocessing operator/post-processing operator may comprise a sub-shape preprocessing operator/processing operator, a PDE parameter function preprocessing operator/processing operator, and a value preprocessing operator/processing operator.

For each of the plurality of sub-shapes SS 8005, the sub-shape operator generation module 8010 may obtain the sub-shape preprocessing operator SO 8015 and the sub-shape post-processing operator SO′ 8025 based on the sub-shape. For example, the range of the sub-shape (e.g., the range 6115 in FIG. 6B for the sub-shape 6105) may be outside the predetermined range of the basic shape in the training data (e.g., 215 in FIG. 2A), and the sub-shape operator generation module 8010 may determine the sub-shape preprocessing operator SO 8015 and the sub-shape post-processing operator SO′ 8025 based on the range 6115 of the sub-shape and the predetermined range of the basic shape 215. For example, the sub-shape preprocessing operator SO 8015 may correspond to a spatial translation and/or spatial scaling of the sub-shape for transforming the range 6115 of the sub-shape to within the predetermined range 215, and the sub-shape post-processing operator SO′ 8025 may be an inverse transformation corresponding to the sub-shape preprocessing operator SO 8015. For example, the predetermined range 215 of the basic shape is the unit square [0.5, 0.5]²⊂R², the range 6115 of the sub-shape is [0, 2]×[0, 2], the sub-shape preprocessing operator SO 8015 may correspond to a spatial shift of [−1,−1] and a spatial scaling of 0.5, and the corresponding sub-shape post-processing operator SO′ 8025 may correspond to a spatial shift of [+1, +1] and a spatial scaling of 2, so that the preprocessed sub-shape is transformed to within the predetermined range of the basic shape as the training data.

Accordingly, for each of the plurality of sub-shapes SS 8005, the sub-shape preprocessing module 8020 may apply the obtained sub-shape preprocessing operator SO 8015 to the sub-shape to obtain the preprocessed sub-shape TS 8035. For example, in examples where the shape is discretized, for any point X(x₁, x₂) in the sub-shape, performing spatial translation on the sub-shape may comprise transforming the point X: (x₁, x₂)→(x₁+t₁, x₂+t₂), and performing spatial scaling on the sub-shape may comprise transforming the point X: (x₁, x₂)→(sx₁, sx₂) or (x₁+t₁, x₂+t₂)→(s(x₁+t₁), s(x₂+t₂)). In one example, the NN model 8050 may obtain an intermediate value for a local solution for each sub-shape of a plurality of sub-shapes based on the preprocessed sub-shape TS 8035. In example, the post-processing module 8060 may apply the sub-shape post-processing operator SO′ 8025 to the intermediate value of the local solution to obtain a local solution for each of the plurality of sub-shapes. For example, the post-processing module 8060 may apply the sub-shape post-processing operator SO′ 8025 to the preprocessed sub-shape TS 8035 to transform it back to the original range of the sub-shape 8005 to obtain a local solution for each of the plurality of sub-shapes. It can be understood that the above transformations are by way of example only, and that any other appropriate transformations may be applied to preprocess/post-process sub-shapes.

For example, the local solution for each sub-shape and the global solution for the shape may be obtained through a plurality of rounds of iteration, and the intermediate value of the local solution for the current (n+1)th round may be expressed as llu(n+1) 8085, where llu(n+1) 8085 may comprise the intermediate value of the local solution for each sub-shape in the plurality of sub-shapes, and the local solution of the sub-shape can be expressed as lu(n+1) 8145, where lu(n+1) 8145 may comprise the local solution for each sub-shape in the plurality of sub-shapes.

Where there is a PDE parameter function in the structural data, the PDE parameter function operator generation module 8030 may obtain the PDE parameter function preprocessing operator PO 8055 and the PDE parameter function post-processing operator PO′ 8065 based on the PDE parameter function P 8045. By way of example, the value range of the PDE parameter function (e.g., PDE parameter function 6065) in the structural data (e.g., the value range of coefficients (such as coefficient fields) and/or source terms (e.g., maximum and/or minimum values)) may be outside the value range of the PDE parameter function in the training data (e.g., [0,1]), and the PDE parameter function operator generation module 8030 may determine the PDE parameter function preprocessing operator PO 8055 and the PDE parameter function post-processing operator PO′ 8065 based on the value range of the PDE parameter function in the structural data and the value range of the PDE parameter function in the training data. For example, the PDE parameter function preprocessing operator PO 8055 may correspond to a value offset and/or value scaling for transforming the value range of the PDE parameter function in the structural data to the value range of the PDE parameter function in the training data, and PDE parameter function post-processing operator PO′ 8065 may be an inverse transformation corresponding to the PDE parameter function preprocessing operator PO 8055.

Accordingly, the PDE parameter preprocessing module 8040 can apply the obtained PDE parameter function preprocessing operator PO 8055 to the PDE parameter function in the structural data to obtain the preprocessed PDE parameter function TP 8075. For example, for coefficient α (or coefficient field a(x)) and/or source term f(x) in the PDE parameter function, the value offset may comprise the transformation: a→a+t, a(x)→a(x′), f(x)→f(x′), and the value scaling can comprise the transformation: a→sa, a(x)→a(x′), f(x)→f(x′). For example, in examples where the shape is discretized, x and x′ the coordinates of the point in the above-mentioned sub-shape 8005 and the coordinates of the corresponding point in the preprocessed sub-shape TS 8035. In one example, the NN model 8050 can obtain an intermediate value llu(n+1) 8085 for a local solution for each sub-shape of a plurality of sub-shapes based on the preprocessed PDE parameter function TP 8075. In one example, the post-processing module 8060 may apply the PDE parameter function post-processing operator PO′ 8065 to the intermediate value of the local solution to obtain a local solution lu(n+1) 8145 for each sub-shape of the plurality of sub-shapes. It can be understood that the above transformations are by way of example only, and that any other appropriate transformations may be applied to preprocess/post-process PDE parameter functions.

For each of the plurality of sub-shapes SS 8005, the local boundary condition module 8070 may set local boundary condition LB 8105 for the sub-shape based on at least one of the global boundary condition B 8085 and the global solution gu(n) 8095 for the shape from a previous round. For example, for each of the plurality of sub-shapes SS 8005, the local boundary condition module 8070 may determine that the local boundary of the sub-shape is associated with only a portion of the global boundary and accordingly set the local boundary condition LB 8105 of the sub-shape to the boundary condition value at the portion of the boundary in the global boundary condition B 8085; alternatively, the local boundary condition module 8070 may determine that the local boundary of the sub-shape is associated with only a virtual boundary (e.g., the virtual boundary does not belong to the global boundary of the shape and may be inside the shape) and accordingly set the local boundary condition LB 8105 of the sub-shape to the global solution value at the virtual boundary in the global solution gu(n) 8095; or alternatively, the local boundary condition module 8070 may determine that: the local boundary of the first portion of the sub-shape is associated with the global boundary of the first portion, the local boundary of the second portion of the sub-shape is associated with the virtual boundary of the second portion, the first local boundary condition in the local boundary conditions LB 8105 of the sub-shape can be set to the boundary condition value at the global boundary of the first portion in the global boundary condition B 8085, and the second local boundary condition in the local boundary conditions LB 8105 of the sub-shape can be set to the global solution value at the virtual boundary of the second portion in the global solution gu(n) 8095.

In one example, the local solution for each of the plurality of sub-shapes is determined based on local boundary conditions for the sub-shape and the sub-shape.

For each of the plurality of sub-shapes SS 8005, the value operator generation module 8080 may obtain the value preprocessing operator VO 8115 and the value post-processing operator VO′ 8125 for the sub-shape based on the local boundary condition LB 8105 for the sub-shape. For example, for each of the plurality of sub-shapes SS 8005, the value range for the local boundary condition LB 8105 of the sub-shape (e.g., based on its maximum and/or minimum value) may be outside the predetermined range (e.g., [0, 1]) of the boundary conditions in the training data, and the value operator generation module 8080 may determine the value preprocessing operator VO 8115 and the value post-processing operator VO′ 8125 based on the value range of the local boundary condition LB 8105 (e.g., based on its maximum and/or minimum value) and the predetermined range of the boundary conditions in the training data. For example, the value preprocessing operator VO 8115 may correspond to a value offset and/or value scaling used to transform the value range of the local boundary condition LB 8105 to within a predetermined range of the boundary conditions in the training data, and the post-processing operator VO′ 8125 may be an inverse transform corresponding to the value preprocessing operator VO 8115.

For each of the plurality of sub-shapes SS 8005, the value preprocessing module 8090 may apply a value preprocessing operator VO 8115 to the local boundary condition LB 8105 to obtain the preprocessed local boundary condition Tlb 8135. For example, the value offset of the value b in the local boundary condition LB 8105 may comprise a transformation: b→b+t, and the value scaling of the value b in the local boundary condition LB 8105 may comprise a transformation: b→sb or b+t→s(b+t). It can be understood that the above transformation is by way of example only, and any other appropriate transformations may be applied to preprocess/post-process the values in the local boundary condition LB 8105.

In one example, the NN model 8050 can obtain an intermediate value llu(n+1) 8085 of a local solution for each of the plurality of sub-shapes based on the preprocessed sub-shape TS 8035 and the preprocessed local boundary condition Tlb 8135 (and the preprocessed PDE parameter function TP 8075, if present). In one example, the post-processing module 8060 may apply a post-processing operator VO′ 8125 to the intermediate value of the local solution to obtain a local solution lu(n+1) 8145 for each of the plurality of sub-shapes. In one example, when the PDE parameter function TP 8045 is included in the structural data, only the PDE parameter function preprocessing operator PO 8055 can be generated without generating the PDE parameter function post-processing operator PO′ 8065. Accordingly, the post-processing module 8060 does not need to consider the PDE parameter function post-processing operator PO′ 8065.

In one example, the NN model 8050 can be trained according to the method described herein. For example, the NN model 8050 may be trained based on training data generated by the method described herein.

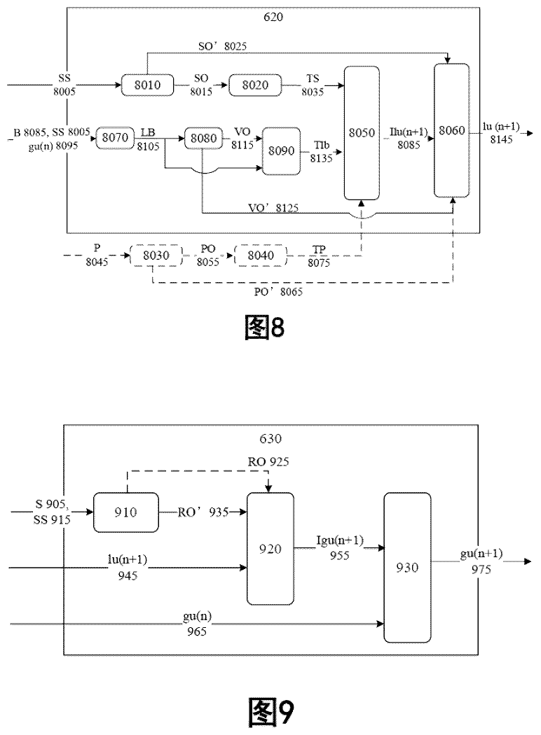

FIG. 9 is a schematic diagram of a global solution module 630 according to one example. In the example of FIG. 9, the global solution module 630 may comprise a restriction and extension operator generation module 910, a concatenation module 920, and an update module 930. It can be understood that the global solution module 630 may comprise other modules, and only the modules related to the examples of the present disclosure are shown in FIG. 9.

The restriction and extension operator generation module 910 may obtain a restriction operator and extension operator for each sub-shape based on each sub-shape of the plurality of sub-shapes SS 915. For example, for each of the plurality of sub-shapes SS 915, the restriction and extension operator generation module 910 can determine which part of the shape S 905 the sub-shape SS 915 is associated with (for example, which discrete points in the shape the sub-shape includes) and accordingly determine the restriction operator RO 925 for restricting the area of shape S 905 to the area of the sub-shape SS 915 and the extension operator RO′ 935 for extending from the area of the sub-shape SS 915 to the area of shape S 905. For example, the restriction operator RO 925 and the extension operator RO′ 935 can be mutually transposed matrices, where the matrix dimension (number of rows and columns) of the extension operator RO′ 935 are the total number of points on the shape S 905 and the local number of points on the sub-shape SS 915, respectively. The elements in the matrix corresponding to the position points of the sub-shape SS 915 are set to 1 and the other elements are set to 0, so that by multiplying the matrix with the solution vector of the sub-shape SS 915, the solution vector of the sub-shape SS 915 can be extended to the dimensions of the solution vector of the shape S 905. On the other hand, transposing of the matrix of the extension operator RO′ 935 can serve as the restriction operator RO 925.

For example, the area of shape S 905 may be a square [−1, 1]², and the region of the first sub-shape SS 915 of the plurality of sub-shapes partitioned from the shape may be a square [−1, 0]². Accordingly, the restriction and extension operator generation module 910 may determine the restriction operator RO 925 for the first sub-shape such that by applying the restriction operator RO 925 to the values on the region of the shape [−1,1]², a first sub-shape in the region [−1, 0]² may be obtained, and it has the value of a portion corresponding to the region [−1, 0]² of the first sub-shape SS 915 among the values of the shape S 905. The restriction and extension operator generation module 910 may also determine the extension operator RO′ 935 for the first sub-shape SS 915 such that by applying the extension operator RO′ 935 to the values on the region [−1, 0]² of the first sub-shape SS 915, an extended sub-shape covering the region ([−1, 1]²) of the shape S 905 can be obtained, in which the extended sub-shape has the same value as the first sub-shape SS 915 in the region [−1, 0]² and can have a default value (e.g., 0) in the other parts of the region [−1, 1]² excluding the region of the first sub-shape SS 915.

In one example, the concatenation module 920 can obtain the intermediate value lgu(n+1) 955 of the global solution for the shape S 905 based on the local solution lu(n+1) 945 for each sub-shape SS 915 and the extension operator RO′ 935 for each sub-shape SS 915. For example, for a sub-shape k among the K sub-shapes SS 915 partitioned from the shape S 905, the concatenation module 920 may apply the extension operator ROₖ′ 935 for the sub-shape k to the local solution lu(n+1)k 945 for the sub-shape (e.g., RO′ₖ(lu(n+1)ₖ)), and the concatenation module 920 may sum the extended local solutions RO′ₖ(lu(n+1)ₖ) for each sub-shape k to obtain an intermediate value lgu(n+1) 955 of the global solution of the shape

$$( e . g . , Igu ( n + 1 ) = {\sum }_{k = 1}^{K} {RO}_{k}^{′} ( {lu ( n + 1 )}_{k} ) .$$

In another example, the concatenation module 920 may obtain an intermediate value lgu(n+1) 955 of the global solution for the shape S 905 based on the local solution lu(n+1) 945 for each sub-shape SS 915, the extension operator RO′ 935 and the restriction operator RO 925 for each sub-shape SS 915, and the global solution gu(n) for the shape S 905 from a previous round

$$( e . g . , Igu ( n + 1 ) = {\sum }_{k = 1}^{K} {RO}_{k}^{′} ( {lu ( n + 1 )}_{k} ) + ( I - {RO}_{k}^{′} {RO}_{k} ) g u ( n ) )$$

wherein I is an identity matrix). In this example, for each sub-shape k, RO′ₖ(lu(n+1) k)+(I−RO′ₖROₖ)gu(n) indicates that within the entire region of the shape, the solution on the subdomain of the sub-shape k is lu(n+1)ₖ and the solution on the subdomain outside the sub-shape k is gu(n).

The update module 930 may obtain the global solution gu(n+1) 975 for the shape based on the intermediate value lgu(n+1) 955 of the global solution for shape S 905 and the global solution gu(n) for the shape S 905 from a previous round.

For example, the update module 930 may obtain the global solution gu(n+1) 975 for the shape S 905 based on a linear combination of the intermediate value lgu(n+1) 955 of the global solution for the shape S 905 and the global solution gu(n+1) 975 for the shape S 905 from a previous round. For example, the update module 930 may calculate the global solution gu(n+1) 975 for the shape S 905 by:

$$gu ( n + 1 ) = ( 1 - τ K ) gu ( n ) + τ Igu ( n + 1 ) \qquad ( 7 )$$

wherein K is the number of sub-shapes, τ is the step length, which is a hyperparameter used to control the convergence rate, and

$$0 < τ < \frac{1}{K} .$$

According to examples of the present disclosure, the SNI operation described herein may be performed based on the following Algorithm 1:

TABLE 1
Algorithm 1

Algorithm 1: Schwarz neutral inference (SNI)
Input: Shape S; global boundary condition B; PDE parameter function P; number of sub-shapes K;
extension depth d; mapping [symbol] of the NN model; step length τ; convergence criterion C;
Output: Global solution gu;
$1 : Apply METIS and d - based shape extension to obtain overlapping \{ {\{ S {S}_{k} \}}_{k = 1}^{K} , obtain the$
$restriction operator \{ \{ {RO}_{k} \} {ε}_{k = 1}^{K} extension operator \{ {\{ {RO}_{k}^{′} \} ;}_{k = 1}^{K}$
2: Initialize global solution gu(0);
3: while convergence criterion C is not met do
4: Using the global boundary condition B and the global solution gu(n) from a previous round, set the
${local boundary condition \{ {B}_{k} \} ;}_{k = 1}^{K}$
5: $Obtain the preprocessing operator {\{ {T}_{k} \}}_{k = 1}^{K} and the post - processing operator \{ {\check{T}}_{{k}_{\cdot k = 1}^{{}^{\cdot } K}} ;$
6: Using the NN model, perform inference for each sub-shape: lu(n + 1)ₖ = Ťₖ ∘ [symbol] ∘ Tₖ(SSₖ, Bₖ);
7: Extend and concatenate local solutions:
$Igu ( n + 1 ) {\sum }_{k = 1}^{K} {RO}_{k}^{′} ( {lu ( n + 1 )}_{k} ) + ( I - {RO}_{k}^{′} {RO}_{k} ) gu ( n ) ;$
8: Update the global solution: gu(n + 1) = (1 − τK)gu(n) + τ Igu(n + 1);
9: n = n + 1;
10: end while
11: return gu(n);

In Algorithm 1 of Table 1, the shape S may also be expressed as a domain Ω and the sub-shape SS_{K} may be expressed as sub-domain Ωₖ. In one example, the convergence criterion C may be gu(n+1) that no longer changes or the amount of change is less than the threshold.

FIG. 10 is a schematic diagram of shapes and the data efficiency of applying SNI to each shape according to examples of the present disclosure. In the first row of FIG. 10, shape SA, shape SB, and shape SC are shown from left to right, respectively.

In the second and third rows of the graph in FIG. 10, the horizontal axis represents the size of the training data set and the vertical axis represents the 12 relative error. In the second row of FIG. 10, a comparison of the 12 relative error between the results of direct inference using GNOT (orange), SNI-based inference (blue), and validation (red) is shown from left to right, respectively, where the Laplace2d-Dirichlet type PDE described herein for Equation (2) is respectively associated with shapes SA, SB, and SC. In the third row of FIG. 10, a comparison of the I₂ relative error between the results of direct inference using GNOT (orange), SNI-based inferences (blue), and validation (red) is shown, where the Darcy2d type PDE described herein for Equation (3) is respectively associated with shapes SA, SB, and SC. Of which, the results of the SNI-based inference and direct inference using GNOT are presented based on reasoning with 100 different boundary conditions. The best validation error during training is also provided as a reference.

Based on the results of SNI data efficiency as shown in FIG. 10, it can be seen that: (1) the relative error of I₂ in SNI is significantly lower than the relative error of GNOT direct inference under circumstances with abundant data; and (2) the error of SNI is equal to or even lower than the validation error with large amounts of data. (3) SNI requires smaller data sets to achieve results that are similar to GNOT direct inference. Taken together, these results suggest that SNI has a substantial advantage in terms of data efficiency. The framework proposed by the examples of the present disclosure has a significant ability to extract more information from limited data and can be extended more efficiently as the amount of data increases.

The method proposed in the examples of the present disclosure perform better on all static problems compared to the baseline that utilizes an NN model such as GNOT to train and reason about the entire shape of an object. The predicted error was reduced by 34.8%-96.8% across all shapes. The excellent performance demonstrates the effectiveness of the method proposed in the examples of the present disclosure in processing arbitrary shapes that are not included in the training data. In particular, since the simple polygons used in the training data may not be sufficiently similar to the complex test shapes, the method proposed in the examples of the present disclosure typically leads by a larger margin on more complex shapes. In addition, during the inference process, the performance of the method of the examples of the present disclosure is consistent when the shapes are different. Among all types of PDEs in the test data set, the difference in predicted error for various shapes was within 3.25%, demonstrating the ability to solve PDEs of various shapes with consistent accuracy using a single trained NN model.

$$( 8 a ) \begin{matrix}{γ}_{1 , left , up} & ( x ) + {k}^{2} u ( x ) = f ,\end{matrix}$$

$$( 8 b ) \begin{matrix}{γ}_{wall} & u ( x ) = {u}_{1} ( x ) ,\end{matrix}$$

$$( 8 c ) \begin{matrix} & u ( x ) = 0 ,\end{matrix}$$

FIG. 11 is a schematic diagram of an object having a shape according to one example. The physical system shown in FIG. 11 corresponds to a guide plate, where the boundary γ₂ to γ₅ in the corresponding grid is the guide plate. The PDE of the physical system associated with the guide plate used for description according to physical law may be:

Where x=(x₁, x₂) represents the spatial coordinates, u=(u₁, u₂) represents the velocity, k is a given constant, and f=f(x) is a given source term, γ_{1, left} represents the left half of γ₁, γ_{1, left,up} represents the upper half of γ_{1, left}, γ_{1, left, down} represents the lower half of γ_{1, left}, γ_{wall}=γ_{1, up}∪γ_{1, down}∪γ₂∪γ₃∪γ₄∪γ₅∪γ_{1, left,down}, and u₁(x)=

In an example, the shape or domain of the object may be represented by geometric parameters that may comprise a center point and radius of a circle with a boundary. In one example, the shape or domain of an object may be represented by a set of discrete points, where each subset of the set of discrete points comprises a discrete point on a corresponding boundary, and the discrete point may be represented by a coordinate. In one example, the shape or domain of an object may be represented by both the aforementioned set parameters and a set of discrete points.

For the exemplary guide plate shown in FIG. 11 and the physical system described by the PDE shown in Equations 8(a) to 8(c), training data may be generated by the method described in combination with FIG. 1 in the examples of the present disclosure, and an NN model for solving the PDE shown in Equations 8(a) to 8(c) for a basic shape to obtain a property state u may be trained. This NN model may be referred to as a local neural operator and may be used in the local solution module 620 shown in FIG. 6A to predict the solution u of the PDE for a sub-shape or sub-domain. Further, for the exemplary guide plate shown in FIG. 8 and the physical system described by the PDE shown in Equations 8(a) to 8(c), the physical state u of the guide plate may be determined by the process described in conjunction with FIG. 6A in examples of the present disclosure.

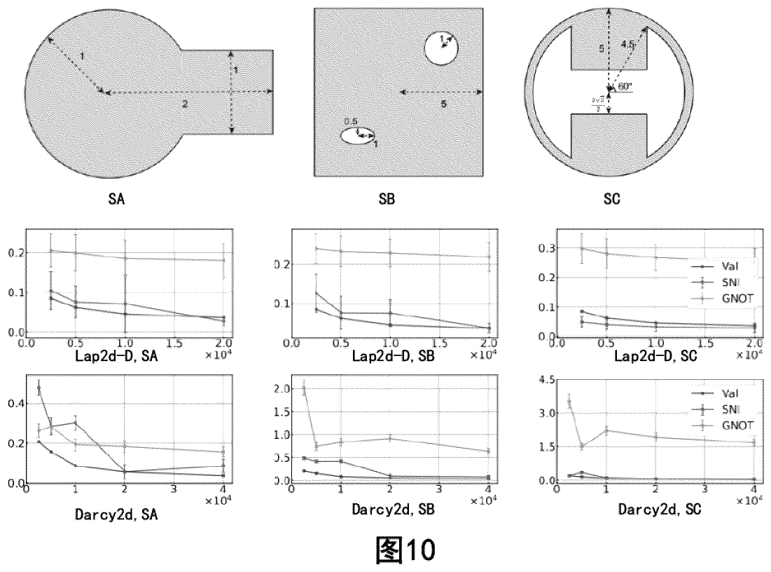

FIG. 12 shows a flow chart of a method for performing structural optimization on an object, such as a guide plate, according to one example. As shown in FIG. 11, the boundaries γ₂ to γ₅ in the grid are the guide plates to be structurally optimized. The goal of the structural optimization is to optimize the shape and position of the guide plates γ₂ to γ₅ to obtain a uniform distribution of fluid flow at the outlet γ_{1, right} on the right so that the energy dissipated by the fluid is very small.

The objective function of structural optimization may be formulated based on fluid mechanics as shown in Equation (15) below:

$$J ( W ) = \frac{1}{2} {\int }_{{γ}_{1 , right}} {\vert {u}_{1} - \overline{{u}_{1}} \vert}^{2} ds + β [ \frac{k}{2} {\int }_{Ω} {‖ ∇ {u}^{⊤} + ∇ u ‖}_{F}^{2} dx ]$$

Where β represents the equilibrium coefficient, for example, β=0.01, u=(u₁, u₂) represents the velocity, k represents the liquid viscosity, and the goal of structural optimization is to minimize J(W).

At Step 1210, a structural parameter quantity is determined, where the structural parameter quantity is used to describe the boundary of the object. For the guide plate shown in FIG. 11 as an object, the structural parameters can include the center and radius of the circular boundaries γ₂ to γ₅. For example, the structural feature W=(x₀, r₀, . . . , x₃, r₃).

At Step 1220, the physical state of the guide plate, i.e., velocity u=(u₁, u₂), is predicted using the SNI method according to one example of the present disclosure (e.g., in conjunction with the process shown in FIG. 6A).

At Step 1130, based on the predicted physical state u=(u₁, u₂) and Equation (15), J(W) is obtained, and based on J(W), the loss (W) is obtained. For example, J(W) can be used as the loss l(W).

The method 1200 then returns to Step 1210, where the structural feature W=(x₀, r₀, . . . , x₃, r₃) is updated based on the loss l(W). The next round of iteration from Step 1120 to 1130 to 1110 is then performed based on the updated structural features.

It can be understood that any suitable method may be used to determine loss l(W) in Step 1130 and that the structural features in Step 1110 may be updated using any suitable method.

In the examples of FIGS. 11 and 12, the guide plate is taken as an example to describe the generation process of training data, the training process of local neural operators, the SNI reasoning process, and the structural optimization process of the object according to the examples of the present disclosure. It can be understood that the various processes described above of the examples of the present disclosure can be applied to various types of objects and various types of PDEs. For example, the object may be a fuel cell bipolar plate, a part of a car, a part of an airplane, a part of a building, a pipe of a reactor, a guide plate, etc., and the physical states associated with the object may include velocity, pressure, temperature, electric field, magnetic field, etc. By employing the methods of the examples of the present disclosure, it is possible to generate sufficient training data for the NN model so that the NN model provides ideal performance, and the physical state of objects of any shape may be determined based on this trained NN model, thereby improving the training and use efficiency of the NN model. It can be understood that when an object has a complex shape, the method according to the examples of the present disclosure has more obvious advantages than the traditional method of training the NN model for solving the entire shape. For example, it is easier to obtain training data for basic shapes, allowing the trained local neural operator to have better generalization ability, effectively process objects with complex shapes, and effectively process objects with large shape changes.

FIG. 13 is a flow chart of a computer-implemented method 1300 for generating training data according to one example.

At Step 1310, a basic shape is generated.

At Step 1320, the boundary conditions associated with the first partial differential equation (PDE) are configured for the boundary of the basic shape.

At Step 1330, a solution of the first PDE for the basic shape is determined based on the basic shape and boundary conditions, where the solution represents the physical state of the object having the basic shape.

According to one example, training data is obtained based on the basic shape, boundary conditions, and solution.

According to one example, the basic shape is limited to a predetermined range. According to one example, the basic shape comprises a planar polygon with no self-intersections and no holes. According to one example, the planar polygon comprises n vertices and 3≤n≤12.

According to one example, the boundary conditions comprise a plurality of types of boundary conditions. According to one example, Step 1320 comprises: partitioning the boundary of the basic shape into a plurality of parts; and configuring one type of boundary condition from the plurality of types of boundary conditions for each of the plurality of parts. According to one example, the boundary conditions comprise a first type of boundary conditions and second type of boundary conditions of the second type, and Step 1320 comprises: partitioning the boundary of the basic shape into a first portion and a second portion; and configuring a first type of boundary condition for the first portion and a second type condition for the second portion. According to one example, the first type of boundary condition is a Dirichlet boundary condition and the second type of boundary condition is a Neumann boundary condition.

According to one example, the value of the boundary condition comprises a random value within a predetermined range.

According to one example, the method 1300 further comprises: configuring a PDE parameter function associated with the first PDE for the basic shape, the PDE parameter function comprising coefficients and/or source terms associated with the first PDE, wherein determining a solution of the first PDE for the basic shape comprises: determining a solution of the first PDE for the basic shape based on the basic shape, boundary conditions, and PDE parameter functions. According to one example, the value of the PDE parameter function comprises a random value within a predetermined range. According to one example, the method further comprises: based on at least one of the basic shape, the value of the boundary condition, the PDE parameter function, and the solution, performing data augmentation to obtain at least one of the data-augmented basic shape, the value of the data-augmented boundary condition, the data-augmented PDE parameter function, and the data-augmented solution; and wherein the training data is based on at least one of the data-augmented basic shape, the value of the data-augmented boundary condition, the data-augmented PDE parameter function and the data-augmented solution as well as the basic shape, the boundary condition, the PDE parameter function, and the solution. According to one example, performing data augmentation based on at least one of the following: the basic shape, the values of the boundary conditions, the PDE parameter function, and the solution comprises performing at least one of: spatial translation, spatial scaling, and/or spatial rotation on the basic shape; and value offset and/or value scaling on at least one of the value of the boundary condition, the PDE parameter function, and the solution.

According to one example, the solution represents the physical state of an object having a basic shape over time.

FIG. 14 shows a flow chart of a computer-implemented method 1400 for training an NN model for determining the physical state of an object having a shape according to one example.

At Step 1410, based on the training data generated according to the method described herein, a solution for the basic shape in the training data is predicted by the NN model, wherein the solution represents the physical state of the object having the basic shape.

At Step 1420, the loss is determined based on the solution predicted by the NN model and the solution in the training data.

At Step 1430, the learnable parameters of the NN model are updated based on the loss.

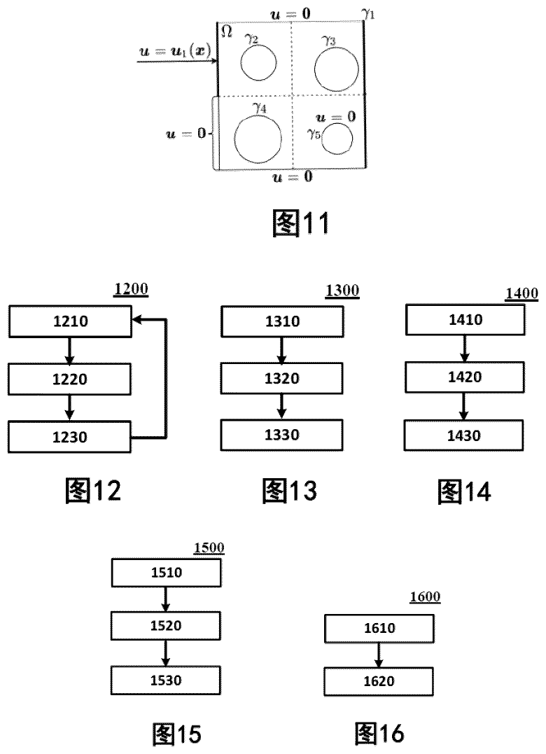

FIG. 15 shows a flow chart of a computer-implemented method 1500 for determining the physical state of an object having a shape according to one example.

At Step 1510, the shape of the object is partitioned into a plurality of sub-shapes, wherein the full set of the plurality of sub-regions corresponding to the plurality of sub-shapes covers the complete area of the shape.

At Step 1520, based on the global boundary conditions for the shape and the plurality of sub-shapes, a local solution for each of the plurality of sub-shapes is obtained through a neural network (NN) model, and the local solution for each sub-shape represents the local physical state of the object with the sub-shape.

At Step 1530, based on the local solution for each of the plurality of sub-shapes, a global solution for the shape is obtained, and the global solution for the shape represents the physical state of the object.

According to one example, Step 1510 comprises: partitioning the shape into a plurality of non-overlapping sub-shapes to form the plurality of non-overlapping sub-shapes; or partitioning the shape into a plurality of overlapping sub-shapes to form the plurality of overlapping sub-shapes. According to one example, forming the plurality of overlapping sub-shapes comprises: partitioning the shape into a plurality of non-overlapping sub-shapes to form the plurality of non-overlapping intermediate sub-shapes; extending some or all of the plurality of non-overlapping intermediate sub-shapes to form the plurality of overlapping sub-shapes.

According to one example, Step 1520 comprises: a local solution for each of the plurality of sub-shapes is also obtained by the NN model based on a PDE parameter function for a differential equation (PDE) corresponding to the NN model, wherein the PDE parameter function comprises coefficients and/or source terms.

According to one example, Step 1520 comprises: obtaining a sub-shape preprocessing model and a sub-shape post-processing model based on the sub-shape and applying the sub-shape preprocessing model to the sub-shape to obtain a preprocessed sub-shape, and/or obtaining a PDE parameter function preprocessing model and a PDE parameter function post-processing model based on the PDE parameter function and applying the PDE parameter function preprocessing model to the PDE parameter function to obtain a preprocessed PDE parameter function; and obtaining a local solution for each of the plurality of sub-shapes based on the preprocessed sub-shape and/or the preprocessed PDE parameter function and based on the sub-shape post-processing model and/or the PDE parameter function post-processing model through the NN model.

According to one example, the local solution for each sub-shape and the global solution for the shape are obtained through a plurality of rounds of iteration, and Step 1520 comprises: setting local boundary conditions for the sub-shape based on the global boundary conditions and at least one of the global solutions for the shape from a previous round; and determining the local solution for the sub-shape through the NN model based on the sub-shape and the local boundary conditions for the sub-shape. According to one example, Step 1530 comprises: obtaining a value preprocessing model and a value post-processing model for the sub-shape based on the local boundary conditions for the sub-shape; applying the value preprocessing model to the local boundary conditions to obtain preprocessed local boundary conditions; determining an intermediate value of a local solution for the sub-shape through the NN model based on the sub-shape and the preprocessed local boundary conditions; and applying a value post-processing operator to the intermediate value of the local solution to obtain a local solution for the sub-shape.

According to one example, the local solution for each sub-shape and the global solution for the shape are obtained through a plurality of rounds of iteration, and Step 1530 comprises: obtaining a restriction model and an extension model for each sub-shape based on each sub-shape in a plurality of sub-shapes; obtaining an intermediate value of a global solution for the shape based on a local solution for each sub-shape and an extension model for each sub-shape, or obtaining an intermediate value of a global solution for the shape based on a local solution for each sub-shape, an extension model and a restriction model for each sub-shape, and a global solution for the shape from a previous round; and obtaining a global solution for the shape based on the intermediate value of the global solution for the shape and the global solution for the shape from a previous round.

According to one example, the solution for the shape represents the physical state of the object having that shape over time.

According to one example, the object is at least one of a fuel cell bipolar plate, a part of a car, a part of an airplane, a part of a building, a pipe of a reactor, and a guide plate, and wherein the physical state comprises at least one of velocity, pressure, temperature, electric field, and magnetic field.

According to one example, the shape of the object in the structural data is represented by at least one of the following: center of circle, radius, width, height, length, grid, or geometric pattern.

According to one example, the NN model is trained by a computer-implemented method described in the present text.

FIG. 16 shows a flow chart of a computer-implemented method 1600 for performing structural optimization of an object according to one example.

At Step 1610, the physical state of the object is predicted using the method described according to examples of the present disclosure.

At Step 1620, the structural features of the object are updated based on the predicted physical state of the object.

According to one example, Step 1620 comprises: updating the shape and/or material of the object based on the predicted physical state of the object.

FIG. 17 shows a block diagram of an apparatus 1700 for generating training data according to one example.

The apparatus 1700 comprises a shape generation module 1710, a boundary condition module 1720, and a solution module 1730. The shape generation module 110 generates a basic shape S 115. The boundary condition module 1720 configures a boundary condition B 125 associated with the first partial differential equation (PDE) for the boundary of the basic shape. The solution module 1730 determines a solution u 135 of the first PDE for the basic shape based on the basic shape S 115 and the boundary condition B 125, wherein the solution represents the physical state of the object having the basic shape. According to one example, the training data is obtained based on the basic shape, boundary conditions, and reconciliation.

According to one example, the basic shape is limited to a predetermined range. According to one example, the basic shape comprises a planar polygon with no self-intersections and no holes. According to one example, the planar polygon comprises n vertices and 3≤n≤12.

According to one example, the boundary conditions comprise a plurality of types of boundary conditions. According to one example, the boundary condition module 1720 configures a boundary condition associated with the first PDE for the boundary of the basic shape by the following modules: a partitioning module for partitioning the boundary of the basic shape into a plurality of parts; and a boundary condition type configuration module for configuring one type of boundary condition from a plurality of types of boundary conditions for each of the plurality of parts. According to one example, the boundary conditions comprise a first type of boundary conditions and a second type of boundary conditions, and the partitioning module partitions the boundary of the basic shape into a first portion and a second portion; the boundary condition type configuration module configures the first type of boundary conditions for the first portion and configures the second type of conditions for the second portion. According to one example, the first type of boundary condition is a Dirichlet boundary condition and the second type of boundary condition is a Neumann boundary condition.

According to one example, the value of the boundary condition comprises a random value within a predetermined range.

According to one example, the apparatus 1700 further comprises a PDE parameter function module configured to configure a PDE parameter function associated with the first PDE for a basic shape, wherein the PDE parameter function comprises coefficients and/or source terms associated with the first PDE, and wherein the solution module determines a solution of the first PDE for the basic shape by: determining a solution of the first PDE for the basic shape based on the basic shape, boundary conditions, and PDE parameter functions. According to one example, the value of the PDE parameter function comprises a random value within a predetermined range. According to one example, the apparatus 1700 further comprises a data augmentation module, which, based on at least one of the basic shape, the value of the boundary condition, the PDE parameter function, and the solution, performs data augmentation to obtain at least one of the data-augmented basic shape, the value of the data-augmented boundary condition, the data-augmented PDE parameter function, and the data-augmented solution; and wherein the training data is based on at least one of the data-augmented basic shape, the value of the data-augmented boundary condition, the data-augmented PDE parameter function and the data-augmented solution as well as the basic shape, the boundary condition, the PDE parameter function, and the solution. According to one example, the data augmentation module performs at least one of the following to perform data augmentation based on at least one of the basic shape, the values of the boundary conditions, the PDE parameter function, and the solution: spatial translation, spatial scaling, and/or spatial rotation on the basic shape; and value offset and/or value scaling on at least one of the value of the boundary condition, the PDE parameter function, and the solution.

According to one example, the solution represents the physical state of an object having a basic shape over time.

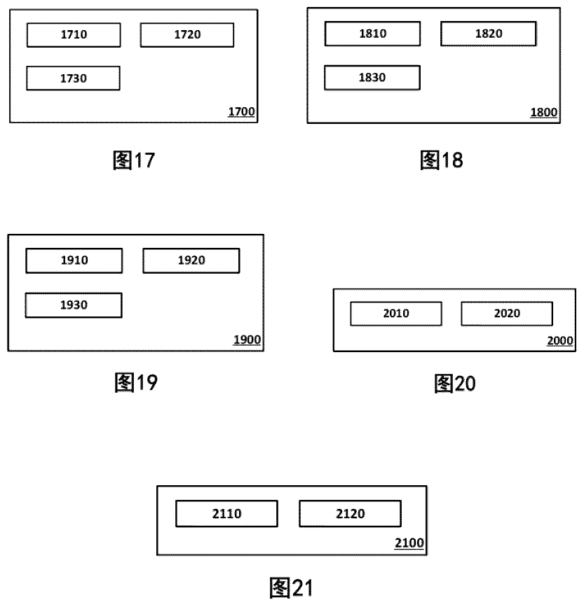

FIG. 18 shows a block diagram of an apparatus 1800 for training an NN model for determining the physical state of an object having a shape according to one example.

The apparatus 1800 comprises an NN model 1810, a loss module 1820, and an update module 1830. The NN model 1810, based on the training data generated according to the method described herein, predicts a solution for the basic shape in the training data, wherein the solution represents the physical state of the object having the basic shape. The loss module 1820 determines the loss based on the solution predicted by the NN model and the solution in the training data. The update module 1830 updates the learnable parameters of the NN model based on the loss.

FIG. 19 shows a block diagram of an apparatus 1900 for determining the physical state of an object having a shape according to one example.

The apparatus 1900 comprises a partitioning module 1910, a local solution module 1920, and a global solution module 1930. The partitioning module 1910 partitions the shape of the object into a plurality of sub-shapes, wherein a full set of a plurality of sub-regions corresponding to the plurality of sub-shapes covers the complete area of the shape. The local solution module 1920, based on the global boundary conditions for the shape and the plurality of sub-shapes, obtains a local solution for each of the plurality of sub-shapes through a neural network (NN) model, and the local solution for each sub-shape represents the local physical state of the object with the sub-shape. The global solution module 1930, based on the local solution for each of the plurality of sub-shapes, obtains a global solution for the shape, and the global solution for the shape represents the physical state of the object.

According to one example, the partitioning module 1910 partitions the shape into the plurality of sub-shapes by comprising the following modules: a non-overlapping partitioning module, which partitions the shape into a plurality of non-overlapping sub-shapes to form the plurality of non-overlapping sub-shapes; or an overlapping partitioning module, which partitions the shape into a plurality of overlapping sub-shapes to form the plurality of overlapping sub-shapes. According to one example, the overlapping partitioning module forms the plurality of overlapping sub-shapes by comprising the following modules: an intermediate partitioning module, which partitions the shape into a plurality of non-overlapping sub-shapes to form the plurality of non-overlapping intermediate sub-shapes; and a shape extension module, which extends some or all of the plurality of non-overlapping intermediate sub-shapes to form the plurality of overlapping sub-shapes.

According to one example, the local solution module 1920 also obtains a local solution for each of the plurality of sub-shapes by performing the following operation: further obtaining a local solution for each of the plurality of sub-shapes using the NN model based on a partial differential equation (PDE) parameter function for a PDE corresponding to the NN model, wherein the PDE parameter function comprises coefficients and/or source terms.

According to one example, the local solution module 1920 obtains a local solution for each of the plurality of sub-shapes through the NN model by the following modules: a sub-shape model generation module, which obtains a sub-shape preprocessing model and a sub-shape post-processing model based on the sub-shape, and a sub-shape preprocessing module, which applies the sub-shape preprocessing model to the sub-shape to obtain a preprocessed sub-shape, and/or a PDE parameter function model generation module, which obtains a PDE parameter function preprocessing model and a PDE parameter function post-processing model based on the PDE parameter function, and a PDE parameter function preprocessing module, which applies the PDE parameter function preprocessing model to the PDE parameter function to obtain a preprocessed PDE parameter function; and the NN model obtains a local solution for each of a plurality of sub-shapes based on the preprocessed sub-shape and/or the preprocessed PDE parameter function and based on the sub-shape post-processing model and/or the PDE parameter function post-processing model.

According to one example, a local solution for each sub-shape and the global solution for the shape are obtained through a plurality of rounds of iteration, and the local solution module 1920 obtains, by the NN model, a local solution for each of the plurality of sub-shapes by comprising the following modules: a local boundary condition module, which sets local boundary conditions for the sub-shape based on the global boundary conditions and at least one of the global solutions for the shape from a previous round; and a local solution determination module, which determines the local solution for the sub-shape through the NN model based on the sub-shape and the local boundary conditions for the sub-shape. According to one example, the local solution module 1920 determines, by the NN model, a local solution for the sub-shape based on the sub-shape and local boundary conditions for the sub-shape by comprising the following modules: a value model generation module, which obtains a value preprocessing model and a value post-processing model for the sub-shape based on the local boundary conditions for the sub-shape; a value preprocessing module, which applies the value preprocessing model to the local boundary conditions to obtain preprocessed local boundary conditions; the NN model determines an intermediate value of a local solution for the sub-shape based on the sub-shape and the preprocessed local boundary conditions; and a post-processing module, which applies a value post-processing model to the intermediate value of the local solution to obtain a local solution for the sub-shape.

According to one example, the local solution for each sub-shape and the global solution for the shape are obtained through a plurality of rounds of iteration, and the global solution module 1930 obtains the global solution for the shape based on the local solution for each sub-shape in the plurality of sub-shapes by comprising the following modules: a restriction and extension model generation module, which obtains a restriction model and an extension model for each sub-shape based on each sub-shape in a plurality of sub-shapes; and a concatenation module, which obtains an intermediate value of a global solution for the shape based on a local solution for each sub-shape and an extension model for each sub-shape, or obtains an intermediate value of a global solution for the shape based on a local solution for each sub-shape, an extension model and a restriction model for each sub-shape, and a global solution for the shape from a previous round; and an update module, which obtains a global solution for the shape based on the intermediate value of the global solution for the shape and the global solution for the shape from a previous round.

According to one example, the solution for the shape represents the physical state of the object having the shape over time.

According to one example, the object is at least one of a fuel cell bipolar plate, a part of a car, a part of an airplane, a part of a building, a pipe of a reactor, and a guide plate, and wherein the physical state comprises at least one of velocity, pressure, temperature, electric field, and magnetic field.

According to one example, the shape of the object in the structural data is represented by at least one of the following: center of circle, radius, width, height, length, grid, or geometric pattern.

According to one example, the NN model is trained according to the computer-implemented method described herein.

FIG. 20 shows a flow chart of a computer-implemented method 2000 for performing structural optimization on an object according to one example.

The apparatus 2000 comprises a prediction module 2010 and an update module 2020. The prediction module 2010 uses the method described according to the examples of the present disclosure to predict the physical state of the object. The update module 2020 updates the structural features of the object based on the predicted physical state of the object.

According to one example, the update module 2020 updates the shape and/or material of the object based on the predicted physical state of the object.

FIG. 21 shows a block diagram of a processing apparatus 2100 according to one example.

The processing apparatus or processing system 2100 comprises one or more control units or processing units 2110 that execute one or more machine-readable instructions stored or encoded in a machine-readable storage medium (i.e., memory 2120). In one example, the processing unit 2110, when executing the program instructions, is configured to perform various operations and functions described above in connection with FIGS. 1-9.

Although not shown in FIG. 1, FIG. 2C, FIG. 3C, FIG. 5, FIG. 6A, FIGS. 7C-9, and FIGS. 17-21, it will be understood by those skilled in the art that the apparatus described in the examples of the present disclosure may also comprise various other components, such as various communication modules, bus modules, possible user interface modules, etc.

According to one example, a program product, such as a non-transitory machine-readable medium, is provided. The non-transitory machine-readable medium may have instructions that, when executed by the processing unit 2110, are capable of performing various operations and functions described above in connection with FIGS. 1 to 20 in various examples of the examples of the present disclosure.

According to one example, a computer program product is provided. The computer program product comprises computer-executable instructions that, when executed by the processing unit 2110, are capable of performing various operations and functions described above in connection with FIGS. 1 to 20 in various examples of the present disclosure.

Exemplary examples are described above with reference to the specific embodiments described in the accompanying drawings, but do not represent all examples that may be implemented or fall within the scope of protection of the patent claims. Throughout the present Specification, the term “exemplary” means “serving as an example, instance, or illustration” and does not imply “preferred” or “advantageous” over other examples. Specific examples comprise specific details to facilitate understanding of the described technology. However, these technologies may be implemented without these specific details. In some instances, to avoid causing difficulties in understanding the concepts of the described examples, known structures and apparatuses are shown in block diagram form.

The aforementioned description of the present application is provided to allow any person of ordinary skill in the art to implement or use the present application. Various modifications to the present application will be apparent to those of ordinary skill in the art, and the general principles defined herein may be applied to other variations without departing from the scope of protection of the present application. Therefore, the present application is not limited to the exemplary examples and designs described herein but is consistent with the broadest scope defined by the principles and novel features disclosed herein.

1. A computer-implemented method for determining the physical state of an object having a shape, comprising:
partitioning the shape of the object into a plurality of sub-shapes, wherein a full set of a plurality of sub-regions corresponding to the plurality of sub-shapes covers the complete area of the shape;
obtaining, based on the global boundary conditions for the shape and the plurality of sub-shapes, a local solution for each of the plurality of sub-shapes using a neural network (NN) model, the local solution for each sub-shape representing a local physical state of the object having the sub-shape; and
obtaining a global solution for the shape based on the local solution for each of the plurality of sub-shapes, the global solution for the shape representing the physical state of the object.

2. The computer-implemented method according to claim 1, wherein partitioning the shape into the plurality of sub-shapes comprises:
partitioning the shape into a plurality of non-overlapping sub-shapes to form the plurality of non-overlapping sub-shapes; or
partitioning the shape into a plurality of overlapping sub-shapes to form the plurality of overlapping sub-shapes.

3. The computer-implemented method according to claim 2, wherein forming the plurality of overlapping sub-shapes comprises:
partitioning the shape into a plurality of non-overlapping sub-shapes to form a plurality of non-overlapping intermediate sub-shapes; and
extending some or all of the plurality of non-overlapping intermediate sub-shapes to form the plurality of overlapping sub-shapes.

4. The computer-implemented method according to claim 1, wherein obtaining a local solution for each of the plurality of sub-shapes using the NN model further comprises:
obtaining a local solution for each of the plurality of sub-shapes using the NN model based on a partial differential equation (PDE) parameter function for a PDE corresponding to the NN model, wherein the PDE parameter function comprises coefficients and/or source terms.

5. The computer-implemented method according to claim 4, wherein obtaining a local solution for each of the plurality of sub-shapes using the NN model comprises:
obtaining a sub-shape preprocessing model and a sub-shape post-processing model based on the sub-shape, and applying the sub-shape preprocessing model to the sub-shape to obtain a preprocessed sub-shape, and/or
obtaining a PDE parameter function preprocessing model and a PDE parameter function post-processing model based on a PDE parameter function, and applying the PDE parameter function preprocessing model to the PDE parameter function to obtain a preprocessed PDE parameter function; and
obtaining a local solution for each of the plurality of sub-shapes using the NN model based on the preprocessed sub-shape and/or the preprocessed PDE parameter function, and based on the sub-shape post-processing model and/or the PDE parameter function post-processing model.

6. The computer-implemented method according to claim 1, wherein the local solution for each sub-shape and the global solution for the shape are obtained through a plurality of rounds of iteration, and wherein obtaining the local solution for each of the plurality of sub-shapes using the NN model comprises performing the following operations for each of the plurality of sub-shapes:
setting local boundary conditions for the sub-shape based on at least one of the following: the global boundary conditions and the global solution for the shape from a previous round; and
determining the local solution for the sub-shape using the NN model based on the sub-shape and the local boundary conditions for the sub-shape.

7. The computer-implemented method according to claim 6, wherein determining a local solution for the sub-shape using the NN model based on the sub-shape and local boundary conditions for the sub-shape further comprises:
obtaining a value preprocessing model and a value post-processing model for the sub-shape based on the local boundary conditions for the sub-shape;
applying the value preprocessing model to the local boundary conditions to obtain preprocessed local boundary conditions;
determining, using the NN model, an intermediate value of the local solution for the sub-shape based on the sub-shape and the preprocessed local boundary conditions; and
applying the value post-processing operator to the intermediate value of the local solution to obtain the local solution for the sub-shape.

8. The computer-implemented method according to claim 1, wherein the local solution for each sub-shape and the global solution for the shape are obtained through a plurality of rounds of iteration, and wherein obtaining the global solution for the shape based on the local solution for each of the plurality of sub-shapes comprises:
obtaining an extension model for each sub-shape based on each of the plurality of sub-shapes;
obtaining an intermediate value of a global solution for the shape based on the local solution for each sub-shape and the extension model for each sub-shape; and
obtaining a global solution for the shape based on an intermediate value of the global solution for the shape and a global solution for the shape from a previous round.

9. The computer-implemented method according to claim 1, wherein the local solution for each sub-shape and the global solution for the shape are obtained through a plurality of rounds of iteration, and wherein obtaining the global solution for the shape based on the local solution for each of the plurality of sub-shapes comprises:
obtaining a restriction model and an extension model for each sub-shape based on each of the plurality of sub-shapes;
obtaining an intermediate value of a global solution for the shape based on the local solution for each sub-shape, the extension model and the restriction model for each sub-shape, and a global solution for the shape from a previous round; and
obtaining a global solution for the shape based on an intermediate value of the global solution for the shape and a global solution for the shape from a previous round.

10. The computer-implemented method according to claim 1, wherein the global solution for the shape represents the physical state of an object having the shape over time.

11. The computer-implemented method according to claim 1, wherein the object is at least one of the following: a fuel cell bipolar plate, a part of an automobile, a part of an aircraft, a part of a building, a reactor pipe, and a guide plate, and wherein the physical state includes at least one of the following: velocity, pressure, temperature, electric field, and magnetic field.

12. The computer-implemented method according to claim 1, wherein the shape of the object is represented by at least one of the following: center of circle, radius, width, height, length, grid, or geometric pattern.

13. The computer-implemented method according to claim 1, wherein the NN model is trained through the following steps:
predicting a solution for a basic shape in training data using the NN model, wherein the solution represents the physical state of an object having the basic shape;
determining a loss based on the solution predicted by the NN model and the solution in the training data; and
updating learnable parameters of the NN model based on the loss.

14. The computer-implemented method according to claim 13, wherein the training data is generated through the following:
generating a basic shape;
configuring boundary conditions associated with a first partial differential equation (PDE) for the boundary of the basic shape;
determining a solution of the first PDE for the basic shape based on the basic shape and the boundary conditions, wherein the solution represents the physical state of an object having the basic shape; and
wherein the training data is obtained at least in part based on the basic shape, the boundary conditions, and the solution.

15. A computer-implemented method for performing structural optimization on an object, comprising:
predicting the physical state of the object using the method according to claim 1; and
updating structural features of the object based on the predicted physical state of the object.

16. An apparatus for determining the physical state of an object having a shape, comprising:
a partitioning module that partitions the shape of the object into a plurality of sub-shapes, wherein a full set of a plurality of sub-regions corresponding to the plurality of sub-shapes covers the complete area of the shape;
a local solution module that obtains, based on the global boundary conditions for the shape and the plurality of sub-shapes, a local solution for each of the plurality of sub-shapes using a neural network (NN) model, the local solution for each sub-shape representing a local physical state of the object having the sub-shape; and
a global solution module that obtains a global solution for the shape based on the local solution for each of the plurality of sub-shapes, the global solution for the shape representing the physical state of the object.

17. An apparatus for performing structural optimization on an object, comprising:
a prediction module that uses the method according to claim 1 to predict the physical state of the object; and
an update module that updates the structural features of the object based on the predicted physical state of the object.

18. A processing apparatus, comprising:
one or more processors; and
one or more memories, the memories having computer-executable instructions stored thereon, and the instructions, when executed by the one or more processors, perform the operations according to claim 1.

19. A machine-readable storage medium having executable instructions stored thereon, the instructions, when executed, causing one or more processors to perform the method according to claim 1.

20. A computer program product comprising executable instructions that, when executed, cause one or more processors to perform the method according to claim 1.
